(19) United States
(12) Patent Application Publication
(10) Pub. No.: US 2019/0327937 A1
(43) Pub. Date: Oct. 31, 2019

(54) ABSORBENT ARTICLE FOR ANIMALS

(71) Applicant: Unicharm Corporation, Ehime (JP)

(72) Inventors: Hiroki Yamamoto, Kanonji-shi (JP); Daisuke Komatsubara, Kanonji-shi (JP)

(73) Assignee: Unicharm Corporation, Ehime (JP)

(21) Appl. No.: 16/465,166

(22) PCT Filed: Aug. 31, 2017
(86) PCT No.: PCT/JP2017/031476

§ 371 Date: May 30, 2019

(30) Foreign Application Priority Data
Nov. 30, 2016 (JP) 2016-233639

(51) Int. Cl. A01K 23/00

(52) U.S. Cl. CPC A01K 23/00

(57) ABSTRACT

An absorbent article for an animal includes: a band part that is fitted in a freely detachable manner around a torso of an animal and has a torso-facing surface facing the torso of the animal when it is worn, and a non-torso-facing surface located on a side opposite the torso-facing surface; and an absorbing body section disposed along a dorsal region, lower crotch region and abdominal region of the animal and having at least one end, from among a dorsal side end located on a dorsal region side of the animal and an abdominal side end located on an abdominal region side of the animal, engaged and fastened in a freely detachable manner with the band part.

### FIELD

The present invention relates to an absorbent article for an animal, such as a disposable diaper, to be used for an animal such as a dog or cat.

### BACKGROUND

Among absorbent articles for animals, for treatment of excreta that have been excreted by pets such as dogs, there are known types that comprise a band-shaped belt that is fitted by wrapping around the torso of the pet, and a disposable diaper that is disposed on the lower crotch region of the pet and anchored in a freely detachable manner to the belt.

As an example of such an absorbent article for an animal, PTL 1 discloses a two-part paper diaper for a bedridden pet, comprising a belt of a stretchable member that is initially wrapped around the torso of a pet, and a diaper body provided with an absorbent body having a structure that is raised at angles at both flanks, wherein the stretchable member used has perforations formed at the front part of the diaper body, and is divided into slits at the rear part of the diaper body. The paper diaper for a pet disclosed in PTL 1, which uses a stretchable member that is divided at the front part and rear part of the diaper body, can follow alterations in the right-left balance of the body shape when the pet lies on its side, and can prevent side leakage of urine or feces by the absorbent body having the structure with angles at both flanks.

### CITATION LIST

### Patent Literature

### [PTL 1] Japanese Unexamined Patent Publication No. 2006-122039

### SUMMARY

### Technical Problem

However, in a paper diaper for a pet such as disclosed in PTL 1, wherein the end on the rear side (dorsal region side) and the end on the front side (abdominal region side) located on both ends in the lengthwise direction of the diaper body (absorbing body section) are folded over from the front side of the band part to the inner side of the band part (the torso-facing surface side) through a belt (band part) fitted on the torso of the animal and bonded with adhesive tape disposed on the torso-facing surface of the band part, the absorbing body section is exposed in a manner covering the surface on the non-torso-facing surface side of the band part, and therefore the end of the absorbing body section in the widthwise direction that is exposed on the surface of the non-torso-facing surface side of the band part can easily catch onto the claws of the animal or onto external structures, often resulting in shifting or detachment of the absorbing body section from the band part.

It is therefore an object of the present invention to provide an absorbent article for an animal comprising a band part and an absorbing body section to be anchored to the band part, wherein the absorbing body section is unlikely to undergo shifting or detachment from the band part.

### Solution to Problem

One aspect (aspect 1) of the invention is an absorbent article for an animal comprising a band part that is fitted in a freely detachable manner around a torso of the animal and has a torso-facing surface facing the torso of the animal when it is worn, and a non-torso-facing surface located on a side opposite the torso-facing surface, and an absorbing body section disposed along a dorsal region, lower crotch region and abdominal region of the animal and having at least one end, from among a dorsal side end located on a dorsal region side of the animal and an abdominal side end located on an abdominal region side of the animal, engaged and fastened in a freely detachable manner with the band part, wherein

the absorbing body section has a longitudinal shape with a lengthwise direction and a widthwise direction in a plan view when in an expanded state, while having an inner surface that faces a skin of the animal when it is worn, and an outer surface on an opposite side from the inner surface, and

at least one end from among the dorsal side end and abdominal side end located at both ends in the lengthwise direction comprises, on at least one surface from among the inner surface and outer surface, an absorbing body section side engagement section that is inserted from a rear side in a front-rear direction of the animal, into a torso-facing surface side of the band part or an interior of the band part, and engages with the torso-facing surface or inner surface of the band part.

In the absorbent article for an animal of aspect 1, since at least one end of the dorsal side end and abdominal side end located at both ends in the lengthwise direction of the absorbing body section comprises, on at least one surface from among the inner surface and outer surface, an absorbing body section side engagement section that is inserted from the rear side in the front-rear direction of the animal into the torso-facing surface side of the band part or the interior of the band part, and engages with the torso-facing surface or inner surface of the band part, and the absorbing body section is not exposed in a manner covering the surface on the non-torso-facing surface side of the band part when the band part and absorbing body section are fitted onto the animal, the end of the absorbing body section in the widthwise direction is unlikely to catch onto the claws of the animal or onto external structures (i.e., it is unlikely to undergo shifting or detachment of the absorbing body section from the band part), and the absorbing body section can be steadily engaged and fastened to the band part.

According to another aspect (aspect 2) of the invention, in the absorbent article for an animal of aspect 1, the band part has a first direction corresponding to a direction around the torso of the animal and a second direction corresponding to the front-rear direction of the animal, while also having a first covering portion that extends from a rear side end in the second direction, located on the rear side of the animal when it is worn, toward a front side end in the second direction, and at least partially extending in the first direction, and a second covering portion that extends in the first direction and the second direction so as to overlap with the first covering portion in a thickness direction of the band part, and is located on a non-torso-facing surface side of the first covering portion,

the inner surface of the band part being formed by a surface on the non-torso-facing surface side of the first covering portion and a surface on the torso-facing surface side of the second covering portion, and

further comprises a band part side engagement section on at least one surface, of the surface on the non-torso-facing surface side of the first covering portion and the surface on the torso-facing surface side of the second covering portion, that engages with the absorbing body section side engagement section.

In the absorbent article for an animal of aspect 2, the band part comprises a band part side engagement section that engages with the absorbing body section side engagement section, on at least one surface from among the surface on the non-torso-facing surface side of the first covering portion and the surface on the torso-facing surface side of the second covering portion, and the location of engagement between the absorbing body section side engagement section and band part side engagement section is covered by the first covering portion and second covering portion, or in other words, it is not exposed either on the surface on the non-torso-facing surface side of the band part or even on the surface on the torso-facing surface side, and therefore the ends of the absorbing body section in the widthwise direction are unlikely to catch onto the claws of the animal or onto external structures, the ends of the absorbing body section in the lengthwise direction are unlikely to contact the torso of the animal (i.e., to rub and crimp or to detach from the torso of the animal), and the absorbing body section can be more steadily engaged and fastened onto the band part.

According to another aspect (aspect 3) of the invention, in the absorbent article for an animal of aspect 2, the band part comprises the band part side engagement section on the surface on the non-torso-facing surface side of the first covering portion,

the absorbing body section comprises the absorbing body section side engagement section on the inner surface, and

the absorbing body section side engagement section of the absorbing body section engages with the band part side engagement section of the surface on the non-torso-facing surface side of the first covering portion.

Since the absorbent article for an animal of aspect 3 is constructed so that the absorbing body section side engagement section of the absorbing body section engages with the band part side engagement section of the surface on the non-torso-facing surface side of the first covering portion, and the location of engagement between the engagement sections is covered by the second covering portion and not exposed on the surface on the non-torso-facing surface side of the band part, then not only the end of the absorbing body section in the widthwise direction but also the end in the lengthwise direction is unlikely to catch onto the claws of the animal or onto external structures, and the absorbing body section can be steadily engaged and fastened with the band part.

Furthermore, since it is possible for the second covering portion of the band part to crimp without engaging with the outer surface of the absorbing body section, the end on the rear side in the second direction of the second covering portion can be turned upward after the absorbing body section side engagement section and band part side engagement section have been engaged, to release the engagement between the engagement sections while adjusting the attachment position and tightening force of the absorbing body section. This allows the absorbent article for an animal of aspect 3 to have the absorbing body section more accurately engaged and fastened onto the band part.

According to yet another aspect (aspect 4) of the invention, in the absorbent article for an animal of aspect 2, the band part comprises the band part side engagement section on the surface on the torso-facing surface side of the second covering portion,

the absorbing body section comprises the absorbing body section side engagement section on the outer surface, and

the absorbing body section side engagement section of the absorbing body section engages with the band part side engagement section of the surface on the torso-facing surface side of the second covering portion.

Since the absorbing body section side engagement section of the absorbing body section in the absorbent article for an animal of aspect 4 is constructed so as to engage with the band part side engagement section of the surface on the torso-facing surface side of the second covering portion, while it does not engage with the surface on the non-torso-facing surface side of the first covering portion, the location of engagement of the band part side engagement section with the absorbing body section side engagement section is less affected by movement of the torso of the animal, and engagement between the engagement sections can be more steadily maintained.

According to yet another aspect (aspect 5) of the invention, in the absorbent article for an animal of aspect 2, the band part comprises the band part side engagement section on both the surface on the non-torso-facing surface side of the first covering portion and the surface on the torso-facing surface side of the second covering portion,

the absorbing body section comprises the absorbing body section side engagement section on both the inner surface and the outer surface, and

the absorbing body section side engagement section on the inner surface and the absorbing body section side engagement section on the outer surface of the absorbing body section engage, respectively, with the band part side engagement section of the surface on the non-torso-facing surface side of the first covering portion and the band part side engagement section of the surface on the torso-facing surface side of the second covering portion, of the band part.

Since the absorbent article for an animal of aspect 5 is constructed so that the absorbing body section side engagement section on the inner surface and the absorbing body section side engagement section on the outer surface of the absorbing body section engage respectively with the band part side engagement section of the surface on the non-torso-facing surface side of the first covering portion and the band part side engagement section of the surface on the torso-facing surface side of the second covering portion of the band part, and the absorbing body section is engaged and fastened onto the band part at both the inner surface and outer surface, the absorbing body section can be more firmly engaged and fastened onto the band part.

According to yet another aspect (aspect 6) of the invention, in the absorbent article for an animal of any one of aspects 2 to 5, the first covering portion and second covering portion have shorter lengths in the second direction than a full length of the band part in the second direction.

Since in the absorbent article for an animal of aspect 6, the lengths of the first covering portion and second covering portion in the second direction (i.e., the front-rear direction of the animal) are shorter than the full length of the band part in the second direction, and the first covering portion and second covering portion do not extend up to the front side end in the second direction of the band part, the ends in the lengthwise direction of the absorbing body section that are engaged and fastened to the band part are unlikely to be exposed from the front side end in the second direction of the band part (i.e., the ends in the lengthwise direction of the absorbing body section are unlikely to catch onto the claws of the animal or onto external structures), and engagement between the engagement sections can be more reliably maintained.

According to yet another aspect (aspect 7) of the invention, in the absorbent article for an animal of aspect 6, the first covering portion and second covering portion extend partially in the first direction.

Since the absorbent article for an animal of aspect 7 is the absorbent article for an animal of aspect 6 further having a construction in which the first covering portion and the second covering portion partially extend in the first direction, the first covering portion and second covering portion are unlikely to crimp, or even if they have become crimped, they can easily return to their original state. This allows the absorbent article for an animal according to aspect 7 to even more reliably maintain the aforementioned engagement between the engagement sections.

According to yet another aspect (aspect 8) of the invention, in the absorbent article for an animal of any one of aspects 2 to 6, the first covering portion and second covering portion extend continuously in the first direction.

Since the absorbent article for an animal of aspect 8 has the first covering portion and second covering portion extending continuously in the first direction (the direction around the torso of the animal), and the absorbing body section can be engaged and fastened at any desired location in the first direction of the band part, the absorbing body section can be engaged and fastened at the proper location of the band part which depends on the body shape of the animal. This allows the absorbent article for an animal of aspect 8 to even more accurately engage and fasten the absorbing body section onto the band part.

### Advantageous Effects of Invention

According to the invention it is possible to provide an absorbent article for an animal comprising a band part and an absorbing body section to be anchored to the band part, wherein the absorbing body section is unlikely to undergo shifting or detachment from the band part.

### BRIEF DESCRIPTION OF DRAWINGS

FIG. 1 is a plan view of the band part 1 of a disposable diaper for an animal according to a first embodiment of the invention, as viewed in the thickness direction from the torso-facing surface side, in the expanded state.

FIG. 2 is a plan view of the band part 1 of a disposable diaper for an animal according to the first embodiment of the invention, as viewed in the thickness direction from the non-torso-facing surface side, in the expanded state.

FIG. 3 is a lengthwise cross-sectional end view of the band part 1, along the widthwise center axis line CL of FIG. 1.

FIG. 4 is a plan view of the absorbing body section 10 of a disposable diaper for an animal according to the first embodiment of the invention, as viewed in the thickness direction from the non-torso-facing surface side, in the expanded state.

FIG. 5 is a perspective view illustrating engagement and fastening of the absorbing body section 10 to the band part 1 in a disposable diaper for an animal according to the first embodiment of the invention.

FIG. 6 is a schematic diagram showing the state in which a disposable diaper for an animal according to the first embodiment of the invention is worn by a dog.

FIG. 7 is a plan view of the band part 1 of a disposable diaper for an animal according to a second embodiment of the invention, as viewed in the thickness direction from the torso-facing surface side, in the expanded state.

FIG. 8 is a plan view of the band part 1 of a disposable diaper for an animal according to the second embodiment of the invention, as viewed in the thickness direction from the non-torso-facing surface side, in the expanded state.

FIG. 9 is a perspective view illustrating engagement and fastening of the absorbing body section 10 to the band part 1 in a disposable diaper for an animal according to the second embodiment of the invention.

FIG. 10(a) is a partial cross-sectional view showing the state of a disposable diaper for an animal according to the second embodiment of the invention, wherein the dorsal side engaging member 18 of the absorbing body section 10 is engaged with the band part side engagement section on the surface of the non-torso-facing surface side of the first covering portion 20 of the band part 1, and FIG. 10(b) is a partial cross-sectional view showing the state of a disposable diaper for an animal according to a modified example of the second embodiment of the invention, wherein the dorsal side engaging member 18 of the absorbing body section 10 is engaged with the band part side engagement section on the surface of the torso-facing surface side of the second covering portion 21 of the band part 1.

FIG. 11 is a perspective view of the band part 1 of a disposable diaper for an animal according to yet another modified example of the second embodiment of the invention.

FIG. 12 is a schematic diagram showing an aspect of the band part 1 of a disposable diaper for an animal according to a third embodiment of the invention.

FIG. 13 is a perspective view of the band part 1 of a disposable diaper for an animal according to a fourth embodiment of the invention.

### DESCRIPTION OF EMBODIMENTS

Preferred embodiments of the absorbent article for an animal of the invention will now be explained in greater detail with reference to the accompanying drawings. Throughout the present description, unless otherwise specified, the concept of “viewing an object (for example, a band part or absorbing body section) on the horizontal plane in the expanded state in the thickness direction of the object, from the upper side in the vertical direction”, will be referred to simply by the phrase “in the plan view”.

The directions used throughout the present description are as follows, unless otherwise specified.

Throughout the present description, “lengthwise direction” refers to the “long direction of the lengths of a longitudinal object (for example, a band part or absorbing body section) in the plan view”, “widthwise direction” refers to the “short direction of the lengths of a longitudinal object in the plan view”, and “thickness direction” refers to the “vertical direction of an object situated on the horizontal plane in the expanded state”, with the lengthwise direction, widthwise direction and thickness direction being in a mutually perpendicular relationship.

Also, throughout the present description, the concept of the “relatively proximal side in the widthwise direction of a longitudinal object (for example, a band part or absorbing body section) with respect to the widthwise center axis line CL located at the center in the widthwise direction of the object and running in the lengthwise direction” is referred to as the “inner side in the widthwise direction”, and the concept of the “relatively distal side in the widthwise direction of a longitudinal object, with respect to the widthwise center axis line CL” is referred to as the “outer side in the widthwise direction”. Similarly, the concept of the “relatively proximal side in the lengthwise direction of a longitudinal object, with respect to the lengthwise center axis line C_{W} located at the center in the lengthwise direction of the object and running in the widthwise direction” is referred to as the “inner side in the lengthwise direction”, and the concept of the “relatively distal side in the lengthwise direction of a longitudinal object, with respect to the lengthwise center axis line C_{W}” is referred to as the “outer side in the lengthwise direction”.

Also throughout the present description, the “direction in which the torso of an animal wearing the band part extends” is referred to as the “front-rear direction of the animal”, the “relatively proximal side with respect to the head of the animal in the front-rear direction of the animal” is referred to as the “front side of the animal”, and the “relatively distal side with respect to the head of the animal in the front-rear direction of the animal” is referred to as the “rear side of the animal”.

Moreover, throughout the present description, unless otherwise specified, the “one side that is the relatively proximal side with respect to the torso of an animal in the thickness direction of the band part and absorbing body section, when the band part and absorbing body section have been fitted onto the torso of the animal”, is referred to as the “torso-facing surface side”, the “other side that is the relatively distal side with respect to the torso of the animal in the thickness direction of the band part and absorbing body section, when the band part and absorbing body section have been fitted onto the torso of the animal” is referred to as the “non-torso-facing surface side”. Incidentally, throughout the present description, the “surface on the torso-facing surface side” and “surface on the non-torso-facing surface side” for the band part, the absorbing body section and each of the members composing them (for example, the core member, inner surface member, outer surface member, top sheet, absorbent body and back sheet) may be referred to simply as “torso-facing surface” and “non-torso-facing surface”, respectively, and in particular, the “torso-facing surface” and the “non-torso-facing surface” of the absorbing body section will be referred to as “inner surface” and “outer surface”, respectively.

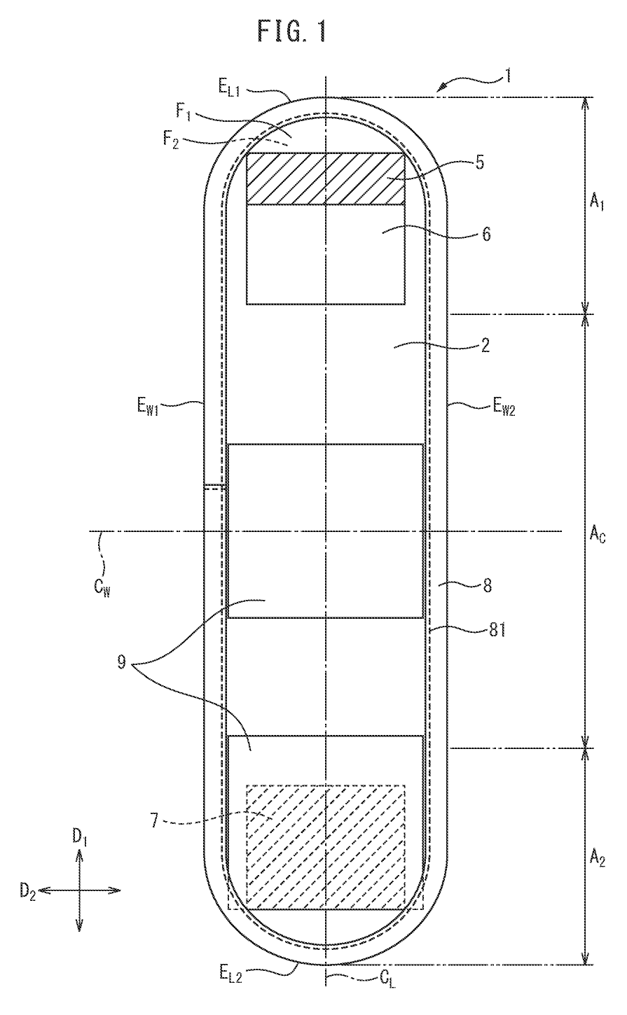

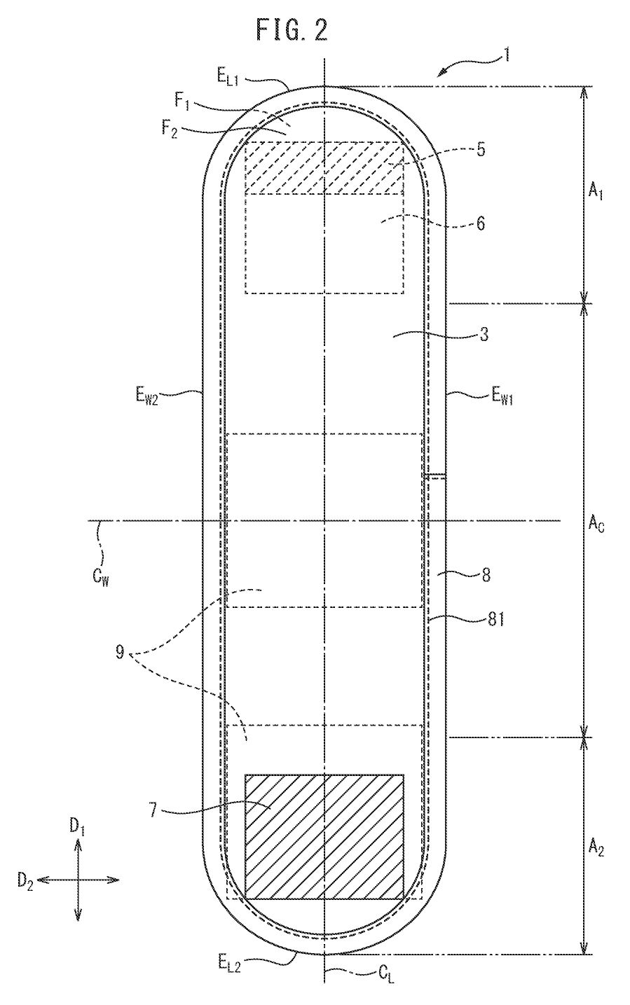

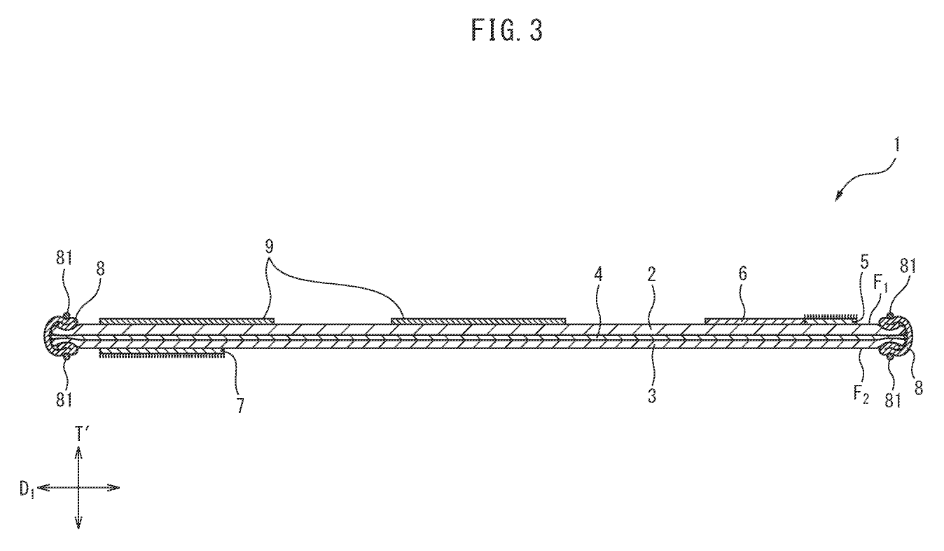

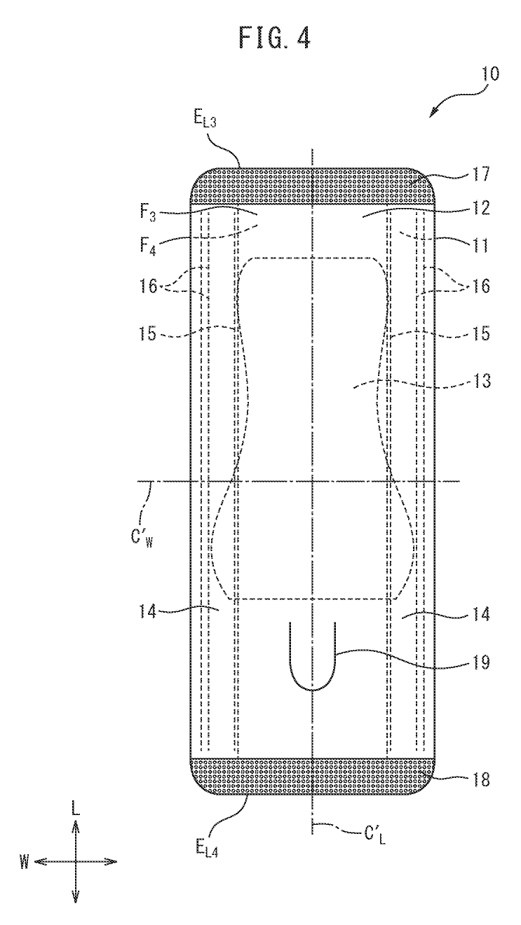

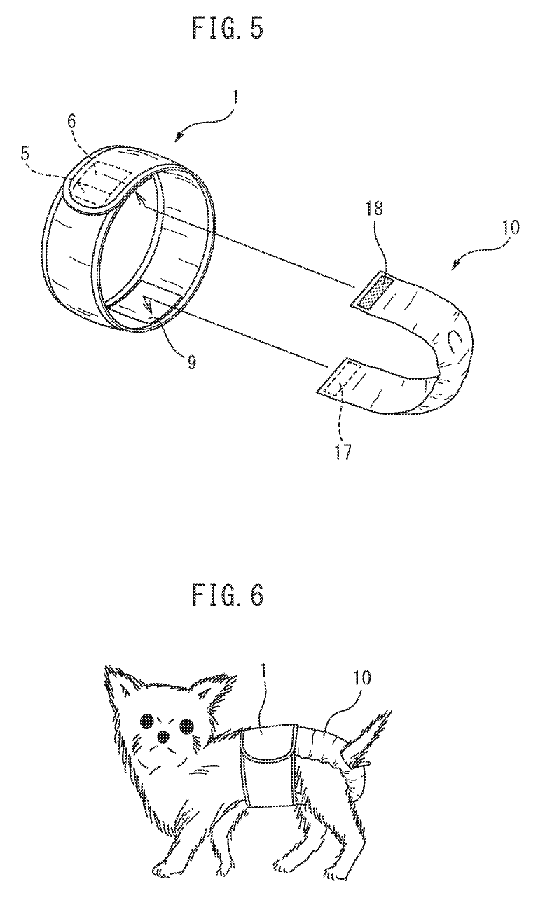

FIG. 1 is a plan view of the band part 1 of a disposable diaper for an animal according to the first embodiment of the invention, as viewed in the thickness direction from the torso-facing surface side, in the expanded state, FIG. 2 is a plan view of the band part 1 as viewed in the thickness direction from the non-torso-facing surface side, in the expanded state, and FIG. 3 is a lengthwise cross-sectional end view of the band part 1, along the widthwise center axis line CL of FIG. 1. Also, FIG. 4 is a plan view of the absorbing body section 10 of a disposable diaper for an animal according to the first embodiment of the invention, as viewed in the thickness direction from the non-torso-facing surface side, in the expanded state, FIG. 5 is a perspective view illustrating engagement and fastening of the absorbing body section 10 to the band part 1 in the disposable diaper for an animal according to the first embodiment of the invention, and FIG. 6 is a schematic diagram showing the state in which the disposable diaper for an animal according to the first embodiment of the invention is worn by a dog (female dog).

As shown in FIGS. 1 to 6, the disposable diaper for an animal according to the first embodiment of the invention has a 2-piece structure comprising a band part 1 fitted in a freely detachable manner along the region around the torso including the dorsal region and abdominal region of an animal such as a dog that is to be fitted and having a torso-facing surface F₁ facing the region around the torso of the animal and a non-torso-facing surface F₂ located on the opposite side from the torso-facing surface F₁, and an absorbing body section 10 disposed along the dorsal region, lower crotch region and abdominal region of the animal (more specifically, disposed in a section from the abdominal region to the dorsal region of the animal, with the lower crotch region of the animal as the center), wherein both ends, i.e. the abdominal side end E_{L3} located on the abdominal region side of the animal and the dorsal side end E_{L4} located on the dorsal region side of the animal, are each engaged and fastened in a freely detachable manner with respect to the torso-facing surface F₁ of the band part 1.

For the first embodiment, as shown in FIG. 6, the band part 1 is a reusable belt-shaped member that is fitted in a freely detachable manner around the torso of an animal such as a dog, including the dorsal region and abdominal region, and serves to support the absorbing body section 10 disposed in the lower crotch region of the animal (i.e., the main body of the disposable diaper for an animal) so that its position does not shift and it does not detach.

Throughout the present description, “reusable” means that it can be formed in a state allowing its reuse by washing and drying in a washing machine or the like, when it has been soiled by excreta or sweat of the animal or other contaminants.

As shown in FIGS. 1 to 3, the band part 1 has a first direction D₁ corresponding to the direction around the torso of the animal (the lengthwise direction of the band part, in the plan view) a second direction D₂ corresponding to the front-rear direction (the widthwise direction of the band part, in the plan view) and a thickness direction T′, while being constructed with a longitudinal outer shape in which each of both edges in the first direction D₁ (i.e., the lengthwise direction) in the plan view (the one side end E_{L1} and other side end E_{L2} in the first direction D₁, in FIG. 1 and FIG. 2) protrude in an arc-shaped fashion toward the outer sides in the first direction D₁, and each of both edges in the second direction D₂ (i.e., the widthwise direction) (the front side end E_{W1} and the rear side end E_{W2} in the second direction D₂, in FIG. 1 and FIG. 2) extend in a straight linear fashion along the first direction D₁, in such a manner as to be wrapped around the torso of the animal (i.e., so that the length of the band part 1 in the first direction D₁ is longer than the length of the waist circumference of the animal).

According to the invention, the outer shape and outer dimensions of the band part are not limited to the aspect of the first embodiment, and so long as it is a longitudinal outer shape having a length in the first direction (length in the lengthwise direction) that is greater than the length of the waist circumference of the animal that is to wear it, any desired longitudinal outer shape (for example, rectangular, rounded-corner rectangular, approximately rectangular with arc-shaped corners, elliptical or hourglass-shaped) and outer dimensions may be employed, depending on the type, body frame and size of the animal.

As shown in FIGS. 1 to 4, the band part 1 of the first embodiment has a torso-facing surface F₁ that faces the torso of the animal and has an anchoring part where the absorbing body section 10 is to be anchored in a freely detachable manner (a band part side engagement section made of a loop member 9, in FIGS. 1 and 2), and a non-torso-facing surface F₂ as the surface on the opposite side from the torso-facing surface F₁, when it is worn, and in the plan view, it has a center region AC located at the center in the first direction D₁ and corresponding to the abdominal region of the animal when it is worn, a first region A₁ extending between the one side end E_{L1} and the center region AC in the first direction D₁ and corresponding to the dorsal region of the animal when it is worn, and a second region A₂ extending between the other side end E_{L2} and the center region AC in the first direction D₁ and corresponding to the dorsal region of the animal when it is worn.

In addition, the band part 1 comprises, in the thickness direction T′, an inner surface member 2 located on the torso-facing surface side of the band part 1 and forming the torso-facing surface F₁ of the band part 1, an outer surface member 3 located on the non-torso-facing surface side of the band part 1 and forming the non-torso-facing surface F₂ of the band part 1, and a core member 4 located between the surface members and imparting prescribed rigidity to the band part 1, while comprising a loop member 6 (first engagement section) that is disposed on the torso-facing surface F₁ of the first region A₁ of the band part 1 and a hook member 7 (second engagement section) that is disposed on the non-torso-facing surface F₂ of the second region A₂ of the band part 1 and is able to engage with the loop member 6, a hook member 5 (third engagement section) that is disposed on the torso-facing surface F₁ of the first region A₁ of the band part 1 in a manner adjacent to the outer side of the loop member 6 in the first direction D₁ (i.e., the lengthwise direction), and is able to engage with the non-torso-facing surface side-engaging section that is located further toward the inner side of the non-torso-facing surface F₂ in the first direction D₁ than the hook member 7, a rigidity-reinforcing member 8 disposed in a manner extending from the torso-facing surface F₁ to the non-torso-facing surface F₂ of the band part 1 (i.e., as trimming) on the outer perimeter edge sections of the band part 1 (i.e., the edge sections along the entire outer perimeter of the band part 1, consisting of the one side end E_{L1} and other side end E_{L2} in the first direction D₁ and the front side end E_{W1} and rear side end E_{W2} in the second direction D₂ of the band part 1), and a loop member 9 (band part side engagement member) that is disposed on the respective torso-facing surface F₁ of the center region AC and second region A₂ of the band part 1, and is able to engage with the absorbing body section side engagement section disposed on the outer surface F₃ consisting of the non-torso-facing surface of the absorbing body section 10 (i.e., the abdominal side engaging member 17 and dorsal side engaging member 18), the construction being such as to allow the band part 1 to be steadily fitted onto the torso of the animal.

For the first embodiment, in the plan view, the inner surface member 2, outer surface member 3 and core member 4 each extend from one side end E_{L1} to the other side end E_{L2} in the first direction D₁ of the band part 1, while also extending from the front side end E_{W1} to the rear side end E_{W2} in the second direction D₂ of the band part 1.

Throughout the present description, the first region in the first direction (i.e., the lengthwise direction) of the band part is a region extending from one side end in the first direction of the band part (for this embodiment, the one side end E_{L1} depicted in FIG. 1 and FIG. 2) toward the inner side in the first direction, in the plan view, the region being that corresponding to the dorsal region of the animal when the band part is put on, and the length in the first direction (i.e., the length in the lengthwise direction) being about ¼ of the length in the first direction of the entire band part. Similarly, the second region in the first direction of the band part is a region extending from the other side end in the first direction of the band part (for this embodiment, the other side end E_{L2} depicted in FIG. 1 and FIG. 2) toward the inner side in the first direction, in the plan view, the region being that corresponding to the dorsal region of the animal when the band part is put on, and the length in the first direction being about ¼ of the length in the first direction of the entire band part. Furthermore, the center region in the first direction of the band part is the region extending between the first region and second region, the region being that corresponding to the abdominal region of the animal when the band part is put on, and the length in the first direction being about ½ of the length in the first direction of the entire band part. The lengths in the first direction of the first region, second region and center region are appropriately set depending on the type, body frame and size of the animal on which the band part is to be fitted.

The anchoring part of the band part is the portion of the torso-facing surface or inner surface of the band part where the absorbing body section is to be anchored in a freely detachable manner (the portion where the absorbing body section side engagement section disposed on the outer surface as the non-torso-facing surface and/or the inner surface as the torso-facing surface of the absorbing body section, described below, is to be engaged and fastened in a freely detachable manner), and although for the first embodiment described above it is formed by the loop member 9, the anchoring part may also be formed by constructing the member that is to form the torso-facing surface or inner surface of the band part (for example, the inner surface member), using a member that is able to engage with the absorbing body section side engagement section.

On the other hand, the absorbing body section 10 of the first embodiment described above is a member disposed on the portion from the abdominal region to the dorsal region of the animal, with the lower crotch region of the animal as the center, and it serves in particular to absorb and retain excreta such as urine that are discharged from the animal, in the lower crotch region of the animal. As shown in FIG. 4, the absorbing body section 10 has an essentially rectangular longitudinal outer shape with a lengthwise direction L and a widthwise direction W, in the plan view in the expanded state, and in the thickness direction T, it has an outer surface F₃ as the non-torso-facing surface, and an inner surface F₄ as the surface on the side opposite the outer surface F₃ (the torso-facing surface), with respect to the torso of the animal, when it is worn.

According to the invention, the outer shape and outer dimensions of the absorbing body section are not particularly restricted, and any longitudinal outer shape (for example, rectangular, elliptical or hourglass-shaped) and outer dimensions may be employed, depending on the type and body frame and size of the animal that is to wear it. For the first embodiment described above, the absorbing body section 10 is constructed by the main body of a disposable diaper for an animal; however, there is no limitation to this aspect for the invention, and the absorbing body section may employ any type of absorbent article main body, such as a (light) incontinence pad main body.

As shown in FIG. 4, the absorbing body section 10 of the first embodiment comprises, as the basic construction in the thickness direction T, a liquid-permeable top sheet 11 situated on the torso-facing surface side of the absorbing body section 10, a liquid-impermeable back sheet 12 situated on the non-torso-facing surface side of the absorbing body section 10, and an absorbent body 13 situated between the sheets and disposed so that, in the plan view, it extends in the lengthwise direction L straddling the lengthwise center axis line C′_{W} that runs in the widthwise direction W of the absorbing body section 10, and extends in the widthwise direction W straddling the widthwise center axis line C′_{L} that runs in the lengthwise direction L, and it is constructed so that excreta such as urine that have been discharged by the animal can be absorbed and held by the absorbent body 13 while penetrating in the thickness direction T.

Also, as shown in FIG. 4, the absorbing body section 10 further comprises an abdominal side engaging member 17 and a dorsal side engaging member 18 (absorbing body section side engagement sections) disposed on the outer surface F₃ of each of both ends in the lengthwise direction L of the absorbing body section 10 (i.e., the abdominal side end E_{L3} and the dorsal side end E_{L4}), a tail opening 19 for insertion of the tail of the animal, disposed at a location between the absorbent body 13 and the dorsal side end E_{L4} in the plan view, and overlapping with the widthwise center axis line C′_{L}, a pair of side sheets 14 disposed on the torso-facing surface side of the top sheet 11 and sandwiching the widthwise center axis line C′_{L}, gather-forming elastic members 15 disposed on the inner side ends in the widthwise direction W of the side sheets 14 and running in the lengthwise direction L, and elastic members 16 disposed on the outer sides in the widthwise direction W of the absorbent body 13, sandwiching the absorbent body 13 in the plan view, in such a manner as to allow steady fitting onto the lower crotch region of the animal while preventing outward leakage of excreta such as urine that have been discharged from the animal.

As shown in FIG. 5 and FIG. 6, the absorbing body section 10 constructed in this manner has both ends in the lengthwise direction L (i.e., the abdominal side end E_{L3} and dorsal side end E_{L4}) inserted from the rear side in the front-rear direction of the animal toward the torso-facing surface side of the band part 1 (more specifically, inserted between the torso-facing surface F₁ of the band part 1 and the torso of the animal), and has the abdominal side engaging member 17 and dorsal side engaging member 18 (absorbing body section side engagement sections), which are disposed on the outer surfaces F₃ of each of both ends, engaging with the loop member 9 (band part side engagement section) on the torso-facing surface F₁ of the band part 1, for engagement and fastening with the band part 1 in a freely detachable manner.

Thus, since the absorbing body section 10 of the disposable diaper for an animal of the first embodiment is not exposed in a manner that would cover the surface on the non-torso-facing surface side of the band part 1, when the band part 1 and absorbing body section 10 are fitted onto the animal, the ends in the widthwise direction W of the absorbing body section 10 are unlikely to catch onto the claws of the animal or onto external structures (i.e., shifting or detachment of the absorbing body section from the band part is unlikely), and the absorbing body section 10 can be steadily engaged and fastened with the band part 1.

Incidentally, for the first embodiment, the absorbing body section side engagement sections are provided on both ends in the lengthwise direction L of the absorbing body section 10; however, when shifting or detachment of the absorbing body section from the band part is minimal even if provided only on one end, due to the type of animal, its habits or its form of rearing (when the animal is bedridden, for example), the absorbing body section side engagement section may be provided only at one end in the lengthwise direction of the absorbing body section. In this case, the other end is either fitted between the band part and the torso of the animal, or it is anchored to the band part by optional bonding means such as a fastening string.

The disposable diaper for an animal of the first embodiment is fitted onto the torso of the animal in the following manner.

First, the band part 1 is set on the torso of the animal so that the first direction D₁ (i.e. the lengthwise direction of the band part 1) matches the direction around the torso of the animal and the center region AC faces the abdominal region of the animal, and is then wrapped around the torso of the animal along the periphery of the torso of the animal. During this time, on the dorsal region of the animal, the first region A₁ on one side in the first direction D₁ of the band part 1 overlaps onto the second region A₂ on the other side (specifically, onto the non-torso-facing surface of the second region A₂), as shown in FIG. 5 and FIG. 6, and the loop member 6 (first engagement section) disposed on the torso-facing surface F₁ of the first region A₁ is engaged and fastened with the hook member 7 (second engagement section) disposed on the non-torso-facing surface F₂ of the second region A₂. Furthermore, the hook member 5 (third engagement section) disposed on the torso-facing surface F₁ of the band part 1 is engaged and fastened to the non-torso-facing surface side-engaging section located further toward the inner side in the first direction D₁ than the hook member 7, on the non-torso-facing surface F₂ of the band part 1, while the one side end E_{L1} in the first direction D₁ of the band part 1 is anchored around the torso of the animal. Since the band part 1 that has been fitted on the torso of the animal in this manner has the one side end E_{L1} in the first direction D₁ anchored around the torso of the animal, the one side end E_{L1} is unlikely to catch onto the claws of the animal or onto external structures (i.e., the band part 1 is unlikely to undergo shifting or detachment from the torso of the animal), and can be steadily fitted onto the torso of the animal.

The the absorbing body section 10 has both ends in the lengthwise direction L (i.e., the abdominal side end E_{L3} and dorsal side end E_{L4}) inserted from the rear side in the front-rear direction of the animal toward the torso-facing surface side of the band part 1 (more specifically, inserted between the torso-facing surface F₁ of the band part 1 and the torso of the animal), and has the abdominal side engaging member 17 and dorsal side engaging member 18 (absorbing body section side engagement sections), which are disposed on the outer surfaces F₃ of each of both ends, engaged and fastened with the loop member 9 (band part side engagement section) that is disposed on the respective torso-facing surfaces F₁ of the center region AC and second region A₂ of the band part 1, for engagement and fastening with the band part 1 in a freely detachable manner.

The “animal” to which the absorbent article for an animal according to the invention is to be applied is not particularly restricted so long as it is an animal that can be reared, such as a pet, and it may be an animal such as a dog, as exemplified by this embodiment, or a cat or monkey. Incidentally, the “excreta” to be absorbed and held by the absorbing body section of the absorbent article for an animal of the invention (for example, a disposable diaper or incontinence pad) are not particularly restricted, and for example, they may be various types of excreta such as urine or feces, or blood.

Each of the members forming the band part and absorbing body section of the absorbent article for an animal of the invention will now be explained in detail using a disposable diaper for an animal according to the first embodiment described above.

### <Band Part>

In addition, the band part 1 in the disposable diaper for an animal of the first embodiment comprises, in the thickness direction T′, an inner surface member 2 forming the torso-facing surface F₁ of the band part 1, an outer surface member 3 forming the non-torso-facing surface F₂ of the band part 1, and a core member 4 situated between the surface members, while comprising a loop member 6 (first engagement section) that is disposed on the torso-facing surface F₁ of the first region A₁ of the band part 1 and a hook member 7 (second engagement section) that is disposed on the non-torso-facing surface F₂ of the second region A₂ of the band part 1 and is able to engage with the loop member 6, a hook member 5 (third engagement section) that is disposed on the torso-facing surface F₁ of the first region A₁ of the band part 1 in a manner adjacent to the outer side of the loop member 6 in the first direction D₁ and is able to engage with the non-torso-facing surface side-engaging section that is located further toward the inner side of the non-torso-facing surface F₂ in the first direction D₁ than the hook member 7, a rigidity-reinforcing member 8 disposed in a manner extending from the torso-facing surface F₁ to the non-torso-facing surface F₂ of the band part 1 on the outer perimeter edge sections of the band part 1, and a loop member 9 (band part side engagement member) that is disposed on the respective torso-facing surfaces F₁ of the center region AC and second region A₂ of the band part 1, and is able to engage with the abdominal side engaging member 17 and dorsal side engaging member 18 (i.e., the absorbing body section side engagement sections) that are disposed on the outer surface F₃ consisting of the non-torso-facing surface of the absorbing body section 10.

In the disposable diaper for an animal according to the first embodiment, only the absorbing body section 10 is made of a disposable member while the band part 1 is composed of a reusable member; however, the absorbent article for an animal of the invention is not limited to such an aspect, and the band part may also be made of a disposable member.

### [Inner Surface Member]

As shown in FIG. 1 and FIG. 3, the inner surface member 2 to be used in the band part 1 for the first embodiment is composed of a flexible sheet member that has, in the plan view, a longitudinal outer shape that extends from one side end E_{L1} across to the other side end E_{L2} in the first direction D₁ of the band part 1 while extending from the front side end E_{W1} to the rear side end E_{W2} in the second direction D₂ (more specifically, a longitudinal outer shape wherein each of both edges in the first direction D₁ protrudes in an arc-shaped manner toward the outer sides in the first direction D₁), and is disposed at a location on the torso-facing surface side in the thickness direction T′ of the band part 1, so as to be able to directly contact the torso of the animal on which it is worn. For the first embodiment, incidentally, since the inner surface member 2 is formed of a non-engaging flexible sheet member that does not engage with any of the hook members used in the engagement sections of the band part 1, the anchoring part is formed of a loop member 9 (band part side engagement section) disposed on the torso-facing surface F₁ of the inner surface member 2; however, the invention is not limited to such an aspect, and the inner surface member may be formed of an engaging flexible sheet member (for example, a loop member or the like) that is able to engage with the absorbing body section side engagement sections of the absorbing body section. If the inner surface member is formed of an engaging flexible sheet member, engagement with the absorbing body section side engagement sections of the absorbing body section may be accomplished over a wide region in the first direction of the band part, thus allowing easier and more precise adjustment of the anchor position of the absorbing body section with respect to the band part.

According to the invention, the flexible sheet member that may be used as the inner surface member is not particularly restricted so long as it has prescribed flexibility allowing it to be used as an inner surface member for the band part, and any of various sheet members may be employed including nonwoven fabrics such as felt or fleece; woven fabrics; knitted fabrics such as a mesh members; natural leather; synthetic leather; or resin sheets such as polyolefin or polyester sheets; however, from the viewpoint of flexibility, air permeability, feel on the skin, ease of care (easy washability) and strength, it is preferred to use a fiber sheet such as a nonwoven fabric, woven fabric or knitted fabric. Among these, it is preferred to use a fiber sheet such as nonwoven fabric or woven fabric or a knitted fabric, from the viewpoint of flexibility, air permeability, feel on the skin, easy treatment (easy washability), and strength. When the flexible sheet member is such a fiber sheet, the constituent fibers are not particularly restricted, and any fibers such as synthetic fibers (such as polyester fiber or nylon fiber), natural fibers (such as cotton or silk), regenerated fibers (such as rayon or cupra) or semisynthetic fibers (such as acetate fibers) may be used, such fibers being used alone, or any two or more different types of fibers being used in combination.

Also, the structure of the flexible sheet member that may be used as the inner surface member is not particularly restricted, and it may be a flat, nonporous sheet member, or it may be a perforated sheet member or a sheet member having a protrusion-recess structure (for example, a protrusion-recess structure with an undulating cross-sectional shape). The flexible sheet member may be either a sheet member with a monolayer structure or a sheet member with a multilayer structure.

The dimensional shape and thickness of the flexible sheet member that may be used as the inner surface member for the invention is not particularly restricted so long as the flexible sheet member can function as an inner surface member for a band part, and any desired dimensional shape and thickness may be employed depending on the desired flexibility, air permeability, feel on the skin and strength.

### [Core Member]

The core member 4 in the band part 1 of the first embodiment is composed of a rigid sheet member that has, in the plan view, the same longitudinal outer shape as the inner surface member 2, that extends from one side end E_{L1} across to the other side end E_{L2} in the first direction D₁ of the band part 1 while extending from the front side end E_{W1} across to the rear side end E_{W2} in the second direction D₂, and is disposed at a location further toward the non-torso-facing surface side than the inner surface member 2 in the thickness direction T′ of the band part 1 (more specifically, a location between the inner surface member 2 and the outer surface member 3), being able to impart a prescribed rigidity or strength to the band part 1.

According to the invention, the rigid sheet member that may be used as the core member is not particularly restricted so long as it has prescribed rigidity allowing it to be used as a core member for the band part, and any of various sheet members may be employed including woven fabrics such as plain weave fabrics; nonwoven fabrics; knitted fabrics; natural leather; synthetic leather; and resin sheets such as polyolefin or polyester sheets, although from the viewpoint of rigidity, consistent flexibility, air permeability and strength, it is preferred to use a fiber sheet such as a nonwoven fabric, woven fabric or knitted fabric. When the rigid sheet member is made of a fiber sheet such as a woven fabric, the constituent fibers are not particularly restricted and may be the same as in the flexible sheet member described above.

The rigidity value of the rigid sheet member to be used as the core member is also not particularly restricted; however, from the viewpoint of ease of wrapping of the band part and the following property for the shape of the torso, it is preferably in the range of 0.5×10⁻⁴ to 12×10⁻⁴ N·m²/m. The rigidity value of a rigid sheet member can be obtained by a flexural rigidity test, i.e by cutting a test piece of a prescribed size (for example, 100 mm×100 mm) from the sheet member to be measured and then measuring the flexural rigidity in each direction of the test piece (i.e., the directions corresponding to the lengthwise direction and widthwise direction of the member being measured) using a KES FB-2 Pure Bending Tester (product of Kato Tech Corp.).

The dimensional shape and thickness of the rigid sheet member that may be used as the core member for the invention is not particularly restricted so long as the rigid sheet member can function as a core member for a band part, and any desired dimensional shape and thickness may be employed depending on the desired rigidity, flexibility and air permeability.

Incidentally, if the band part has the rigidity or strength for the band part as a whole that is prescribed according to the invention, due to structural members other than the core member (for example, the inner surface member or outer surface member, the engaging members and the rigidity-reinforcing member), the band part does not necessarily need to comprise such a core member.

### [Outer Surface Member]

As shown in FIG. 2 and FIG. 3, the outer surface member 3 of the band part 1 of the first embodiment is composed of an engaging sheet member that has, in the plan view, the same longitudinal outer shape as the inner surface member 2 that extends from one side end E_{L1} across to the other side end E_{L2} in the first direction D₁ of the band part 1 while extending from the front side end E_{W1} across to the rear side end E_{W2} in the second direction D₂, and that is disposed at a location on the non-torso-facing surface side (specifically, a location further toward the non-torso-facing surface side than the core member 4) in the thickness direction T′ of the band part 1, and is able to engage with the hook member 5 (third engagement section) disposed on the torso-facing surface F₁ of the first region A₁ of the band part 1. For the first embodiment, therefore, the non-torso-facing surface side-engaging section, which is located further toward the inner side in the first direction D₁ than the hook member 7 (second engagement section) on the non-torso-facing surface F₂ of the second region A₂ of the band part 1, is constructed as part of the non-torso-facing surface F₂ of the outer surface member 3.

According to the invention, the engaging sheet member that may be used as the outer surface member is not particularly restricted so long as it has the prescribed engaging structure (for example, a loop structure or a fiber aggregate structure having prescribed fiber lengths and interfiber distances) which allows the engaging member (i.e., the hook member composing the third engagement section of the band part) to engage with at least portions of the surface that serves as the non-torso-facing surface of the band part, and also so long as it has prescribed flexibility and strength allowing it to be used as an outer surface member for the band part; for example, it may be a sheet-like loop member composed of a knitted fabric having a base and a plurality of loop sections integrally formed by synthetic fibers; a sheet-like loop member comprising a molded article having a base section and a plurality of loop sections integrally formed by a synthetic resin such as polyester; or a sheet member such as a nonwoven fabric; however, from the viewpoint of easier engagement with different engaging members, as well as engaging strength and flexibility, it is preferred to use a sheet-like loop member having a base and a plurality of loop sections. Of these, it is preferred to use a sheet-like loop member having a base and a plurality of loop sections, from the viewpoint of easy engagement with the engaging member, engagement strength, and flexibility. In the first embodiment described above, the outer surface member 3 is composed of a sheet-like loop member having a base and a plurality of loop sections.

When the engaging sheet member that can be used as the outer surface member of the band part is composed of a sheet-like loop member comprising such a molded article, the constituent material is not particularly restricted and may be, for example, a synthetic resin such as a polyester or polyolefin, either as a single type of synthetic resin, or two or more of such resins in combination. Even when the engaging sheet member is made of a sheet-like loop member comprising the aforementioned knitted fabric, or of a nonwoven fabric, the constituent fibers are not particularly restricted and may be the same as in the flexible sheet member described above.

The engaging sheet member that may be used as the outer surface member does not need to have the engaging structure described above for the entirety of the engaging sheet member, it being sufficient if the engaging structure is in a section of the band part capable of engaging with the third engagement section. Therefore, the engaging sheet member may have the sections other than the section with the engaging structure formed of any arbitrary sheet member (for example, the same type of fiber sheet as the inner surface member).

Incidentally, since the third engagement section of the band part is not an essential constituent feature of the invention, if the band part does not have a third engagement section, the outer surface member does not necessarily need to be an engaging sheet member, and any desired sheet member (for example, a flexible sheet member similar to the inner surface member described above) may be used.

The dimensional shape and thickness of the flexible sheet member that may be used as the outer surface member for the invention is not particularly restricted so long as the flexible sheet member can function as an outer surface member for a band part, and any desired dimensional shape and thickness may be employed depending on the desired rigidity, flexibility and air permeability.

### [Engaging Members]

According to the first embodiment, as shown in FIGS. 1 to 3, the band part 1 comprises, as anchoring means to maintain the fitted state of the band part 1 on the torso of the animal, a loop member 6 (first engagement section) that is disposed on the torso-facing surface F₁ of the first region A₁ of the band part 1, a hook member 7 (second engagement section) that is disposed on the non-torso-facing surface F₂ of the second region A₂ of the band part 1 and is able to engage with the loop member 6, and a hook member 5 (third engagement section) that is disposed on the torso-facing surface F₁ of the first region A₁ of the band part 1 so as to be adjacent to the outer sides in the first direction D₁ (this, the lengthwise direction) of the loop member 6, and it further comprises a loop member 9 (band part side engagement member) disposed on the torso-facing surface F₁ of each of the center region AC and second region A₂ of the band part 1, as anchoring means for anchoring of the absorbing body section 10 to the band part 1 (more specifically, for anchoring of the absorbing body section 10 to the band part 1 by engagement and fastening between the abdominal side engaging member 17 and dorsal side engaging member 18 (absorbing body section side engagement sections) disposed on the outer surface F₃ of the absorbing body section 10).

The engaging members (hook member and loop member) to be used in the band part will now be explained in greater detail using the band part 1 of a disposable diaper for an animal according to the first embodiment described above.

As used herein, “engagement” means a state in which elements with a prescribed structure are connected by mechanically interlocking and the connected state is maintained unless the elements are pulled with a prescribed force, and a typical example of an “engaging member” is a “hook-and-loop fastener”.

### (First Engagement Section)

According to the first embodiment, the loop member 6 (first engagement section) disposed on the torso-facing surface F₁ of the first region A₁ of the band part 1 has an essentially rectangular outer shape that is long in the second direction D₂ of the band part 1 in the plan view, as shown in FIG. 1, and it is constructed so as to be able to engage with the hook member 7 (second engagement section) that is disposed on the non-torso-facing surface F₂ of the second region A₂ of the band part 1.

According to the invention, the loop member that may form the first engagement section is not particularly restricted so long as it is able to engage with the hook member of the second engagement section, and for example, a sheet-like loop member similar to the outer surface member described above may be used. For the first embodiment, the loop member 9 (band part side engagement member) disposed on each torso-facing surface F₁ of the center region AC and second region A₂ of the band part 1 is also composed of a loop member having the same structure as the loop member 6 (first engagement section).

The first engagement section used for the invention is not limited to a loop member, and may be a hook member instead. In this case, the second engagement section is formed by the loop member. However, the first engagement section is preferably formed of a loop member as in the first embodiment. If the first engagement section disposed on the torso-facing surface of the band part is formed by such a loop member, then the loop member will have engaging recesses (i.e. loop sections) that receive the engaging protrusions of the second engagement section, while lacking engaging protrusions, and therefore when the band part is put on, it will be possible to prevent the animal's hair from becoming tangled with the first engagement section disposed on the torso-facing surface of the band part, or to prevent itchy irritation of the torso of the animal by the engaging protrusions. This band part therefore makes it even less likely that the animal will exhibit dissatisfaction when the article is worn, or that the band part will shift or detach from its proper position.

The dimensional shape and thickness of the first engagement section for the invention is not particularly restricted so long as it can engage with the second engagement section, and any dimensional shape and thickness may be employed depending on the desired engaging strength, rigidity and flexibility.

### (Second Engagement Section)

According to the first embodiment, the hook member 7 (second engagement section) disposed on the non-torso-facing surface F₂ of the second region A₂ of the band part 1 has an essentially rectangular outer shape that is long in the second direction D₂ of the band part 1 in the plan view, as shown in FIG. 2, and it is constructed so as to be able to engage with the loop member 6 (first engagement section) that is disposed on the torso-facing surface F₁ of the first region A₁ of the band part 1. As shown in FIG. 3, the hook member 7 (second engagement section) has a base disposed on the non-torso-facing surface F₂ of the outer surface member 3 and a plurality of engaging protrusions protruding from the base to the non-torso-facing surface side, with each of the plurality of engaging protrusions having a shaft portion running from the base toward the non-torso-facing surface side, and at the end of the shaft portion (specifically, the end of the shaft portion located at the opposite side from the base), a widening portion expanding in the direction in which the outer peripheral surface of the shaft portion widens, or in other words, it is composed of a mushroom-type hook member. For this embodiment, the hook member 5 (third engagement section) disposed on the torso-facing surface F₁ of the first region A₁ of the band part 1 of the first embodiment is also composed of a hook member having the same structure as the hook member 7 (second engagement section).

According to the invention, the hook member that may form the second engagement section is not limited to a hook member having the structure specified above (i.e., a mushroom-type hook member), and for example, it is suitable to use a hook member having any of various structures, including a structure in which the tips of the shaft portions are folded toward the base, also known as a key-type hook member. However, if a hook member having the specified structure is used as a hook member for the second engagement section, and if the hook member is engaged and fastened to the loop member (first engagement section) disposed on the torso-facing surface of the band part, it is possible to maintain the engaged state of the hook member (second engagement section) on the loop member in response to various directions of force, even when the engaged and fastened portion gets pulled in different directions by movement of the animal, and therefore the engaged state of the hook member (second engagement section) and the loop member (first engagement section) can be more firmly maintained, so that as a result, the band part is even less likely to shift from the proper position on the torso of the animal and even less likely to slip off from the torso of the animal. In addition, since the hook member having such a specific structure can engage with any fiber structure even if it is not a loop member with a specific engaging structure (for example, a nonwoven fabric or knitted fabric), there is no need to form the first engagement section of a prescribed loop member, thereby allowing various product designs to be realized for different types of product concepts designed for resource savings or cost reduction.

The constituent materials of the hook member that can form the second engagement section are not particularly restricted, and any desired synthetic resins such as polyesters or polyolefins, polyamides, polyvinyl chloride, olefin-based elastomers or urethane-based elastomers, for example, may be used, such synthetic resins being single types of resins or combinations of two or more different resins.

The second engagement section used for the invention is not limited to a hook member, and may be a loop member instead. In this case, the first engagement section is formed by the hook member. However, the second engagement section is preferably formed by a hook member having a plurality of engaging protrusions, as in the first embodiment described above. If the second engagement section disposed on the non-torso-facing surface of the band part is formed by such a hook member having a plurality of engaging protrusions, the first engagement section that engages with the hook member will be formed by a loop member that has engaging recesses (i.e. loop sections) that receive the engaging protrusions of the hook member, while lacking engaging protrusions, and therefore when the band part is put on, it will be possible to prevent the animal's hair from becoming tangled with the first engagement section disposed on the torso-facing surface of the band part, or to prevent itchy irritation of the torso of the animal by the engaging protrusions. This band part therefore makes it even less likely that the animal will exhibit dissatisfaction when the article is worn, or that the band part will shift or detach from its proper position.

Also, if the band part comprises the first engagement section and second engagement section, then when the band part is fitted around the torso of an animal, in the dorsal region of the animal, engagement and fastening can be achieved by the first engagement section and second engagement section, while the first region on one side in the first direction of the band part (i.e., the lengthwise direction of the band part) is overlapping with the second region on the other side (i.e., on the non-torso-facing surface of the second region), and therefore a band part comprising such a first engagement section and second engagement section has the first region and second region overlapping through the engagement sections when the band part is put on, the overlapping portions being formed so as to extend in the second direction of the band part (i.e., the direction corresponding to the front-rear direction of the animal). Thus, in the region of the band part corresponding to the dorsal region of the animal, rigidity is increased in the direction corresponding to the front-rear direction of the animal, and therefore even with movement of the animal wearing the band part, so that it bends around the abdominal region, the band part is unlikely to bend in the second direction, so that as a result, the center region of the band part is less likely to deform in the direction corresponding to the front-rear direction of the animal, and the absorbing body section anchored to the band part can persistently and accurately contact the lower crotch region of the animal.

Incidentally, the dimensional shape and thickness of the second engagement section for the invention is not particularly restricted so long as it can engage with the first engagement section, and any dimensional shape and thickness may be employed depending on the desired engaging strength, rigidity and flexibility.

### (Third Engagement Section)

For the first embodiment described above, the hook member 5 (third engagement section) that is disposed on the torso-facing surface F₁ of the first region A₁ of the band part 1 has an essentially rectangular outer shape that is long in the second direction D₂ of the band part 1, in the plan view, and it is constructed so as to be able to engage with the non-torso-facing surface side-engaging section located further toward the inner side in the first direction D₁ than the hook member 7 (second engagement section), on the non-torso-facing surface F₂ of the band part 1. For the first embodiment, the hook member 5 (third engagement section) is constructed of a hook member having the same structure as the hook member 7 of the second engagement section described above.

Incidentally, while providing the band part with such a third engagement section is not an essential constituent feature for the invention, the band part preferably comprises such a third engagement section on the torso-facing surface further toward the outer side in the first direction than the first engagement section. If the band part is provided with the third engagement section, the third engagement section will engage with the non-torso-facing surface side-engaging section located further toward the inner side in the first direction than the second engagement section, on the non-torso-facing surface of the band part, such that one side end in the first direction of the band part will be anchored around the torso of the animal, and therefore that one side end will be unlikely to catch onto the claws of the animal or onto external structures, and the band part can be more steadily fitted onto the torso of the animal.

According to the invention, the hook member that can form the third engagement section is not particularly restricted so long as it can engage with the non-torso-facing surface side-engaging section, and for example, the same type of hook member may be used as for the second engagement section.

Incidentally, if the third engagement section is formed by a hook member having a plurality of engaging protrusions that protrude toward the torso-facing surface side, similar to the hook member of the second engagement section, then the non-torso-facing surface side-engaging section that engages with the hook member will be formed by a complementary engaging member having engaging recesses that can receive the engaging protrusions of the hook member while lacking engaging protrusions (a loop member, for example), thus helping to prevent the rigidity of the non-torso-facing surface side-engaging section from increasing by the presence of engaging protrusions. Since this allows the band part to ensure a wider non-torso-facing surface side-engaging section without increasing the rigidity of the band part, the band part can be fitted with more appropriate tightening force at the optimal position of the animal.

Incidentally, the dimensional shape and thickness of the third engagement section for the invention is not particularly restricted so long as it can engage with the non-torso-facing surface side-engaging section, and any dimensional shape and thickness may be employed depending on the desired engaging strength, rigidity and flexibility.

### (Band Part Side Engagement Section)

For the first embodiment, the loop member 9 (band part side engagement section) disposed on each torso-facing surface F₁ in the center region AC and second region A₂ of the band part 1 has an essentially rectangular outer shape with prescribed lengths in the first direction and second direction, in the plan view, and it is constructed so that the abdominal side engaging member 17 disposed on the outer surface F₃ of the absorbing body section 10 and the dorsal side engaging member 18 (absorbing body section side engagement section) can engage.

According to the invention, the loop member that may form the band part side engagement section is not particularly restricted so long as it is able to engage with the hook member of the absorbing body section side engagement section of the absorbing body section, and for example, a sheet-like loop member having a structure similar to the first engagement section described above may be used.

The band part side engagement section used for the invention is not limited a loop member, and may be a hook member instead. In this case, the absorbing body section side engagement section of the absorbing body section is formed of a loop member. However, the band part side engagement section is preferably formed of a loop member as in the first embodiment. If the band part side engagement section disposed on the torso-facing surface of the band part is formed by such a loop member, then the loop member will have engaging recesses (i.e. loop sections) that receive the engaging protrusions of the absorbing body section side engagement section, while lacking engaging protrusions, and therefore when the band part is put on, it will be possible to prevent the animal's hair from becoming tangled with the band part side engagement section disposed on the torso-facing surface of the band part, or to prevent itchy irritation of the torso of the animal by the engaging protrusions. This band part therefore makes it even less likely that the animal will exhibit dissatisfaction when the article is worn, or that the band part will shift or detach from its proper position.

According to the invention, when the inner surface member is formed of an engaging flexible sheet member that can engage with the absorbing body section side engagement section of the absorbing body section (for example, a loop member) (i.e., when the torso-facing surface of the inner surface member is the band part side engagement section), the band part does not necessarily have to be provided with the aforementioned engaging member. Moreover, for the first embodiment, the loop member 9 (band part side engagement section) is disposed on the torso-facing surface F₁ of each of the center region AC and second region A₂ of the band part 1; however, the present invention is not limited to such an aspect, and when the absorbing body section side engagement section of the absorbing body section is disposed on one end among the abdominal side end and dorsal side end located at both ends in the lengthwise direction of the absorbing body section, as explained below, the band part side engagement section may be disposed on the torso-facing surface of either the center region or the second region of the band part corresponding to the absorbing body section side engagement section.

The dimensional shape and thickness of the band part side engagement section for the invention is not particularly restricted so long as it can engage with the absorbing body section side engagement section of the absorbing body section, and any dimensional shape and thickness may be employed depending on the desired engaging strength, rigidity and flexibility.

### [Rigidity-Reinforcing Member]

For the first embodiment, the band part 1 comprises, as means for imparting prescribed rigidity (strength) to the band part 1, a rigidity-reinforcing member 8 disposed at the outer perimeter edge section of the band part 1, extending from the torso-facing surface F₁ of the band part 1 (specifically, the torso-facing surface of the inner surface member 2) to the non-torso-facing surface F₂ (specifically the non-torso-facing surface of the outer surface member 3).

While providing the band part with such a rigidity-reinforcing member is not an essential constituent feature for the invention, the band part preferably has the rigidity-reinforcing member extending in at least the first direction. If the band part has a rigidity-reinforcing member extending in the first direction, then even when force is applied in the second direction of the band part (i.e., the direction corresponding to the front-rear direction of the animal) due to activity of the animal when the band part is put on, it will be able to resist the force due to the rigidity-reinforcing member extending in the direction intersecting with that direction (i.e., the first direction of the band part), so that the band part will be less likely to deform in the second direction and the absorbing body section anchored to the band part will be even more reliably rendered unlikely to detach.

Furthermore, for the first embodiment, the rigidity-reinforcing member 8 consists of a single belt-shaped member, and as shown in FIGS. 1 to 3, it is disposed at the outer perimeter edge section of the band part 1 in a manner sandwiching a laminate of the inner surface member 2, the core member 4 and the outer surface member 3, from both the torso-facing surface side and the non-torso-facing surface side, while the rigidity-reinforcing member 8, inner surface member 2, core member 4 and outer surface member 3 on the torso-facing surface side and the rigidity-reinforcing member 8 on the non-torso-facing surface side are integrally joined by stitching in the thickness direction T′ by stitching thread 81. Incidentally, the means for joining the rigidity-reinforcing member to the outer perimeter edge section of the band part is not particularly restricted, and instead of stitching means, it may be any other joining means including compression means such as embossing, bonding means using a hot-melt adhesive, or heat fusion means using ultrasonic waves or the like.

The belt-shaped member that may be used as the rigidity-reinforcing member for the invention is not particularly restricted so long as it is a belt-shaped member having constant rigidity (strength), and a belt-shaped member made of a woven fabric, nonwoven fabric, resin film or laminated sheet of two or more of these in combination, for example, may be used. The belt-shaped member preferably has stretchability in the lengthwise direction, from the viewpoint of facilitating fitting of the band part onto the torso of the animal. Examples of belt-shaped members having stretchability in the lengthwise direction include bias tape with interwoven urethane fiber, woven fabrics with interwoven elastic members such as polyurethane fiber or rubber, stretchable nonwoven fabrics containing elastic members, and net-like fabrics formed by weaving synthetic fibers or natural fibers. The rigidity-reinforcing member 8 used for the first embodiment is bias tape having stretchability in the lengthwise direction.

The dimensional shape and thickness of the belt-shaped member to be used as the rigidity-reinforcing member for the invention are not particularly restricted so long as it can function as the rigidity-reinforcing member, and any dimensional shape and thickness may be employed depending on the desired rigidity and flexibility.

The method of producing the band part using each of the aforementioned members is not particularly restricted, and for example, the band part may be produced by laminating the inner surface member and outer surface member, and the engaging members, optionally using joining means (for example, bonding means or stitching means), to obtain a laminate, and then if necessary joining the rigidity-reinforcing member to the outer perimeter edge section of the laminate using any desired joining means.

### <Absorbing Body Section>

In the disposable diaper for an animal of the first embodiment, the absorbing body section 10 is constructed of a main body of the disposable diaper for an animal, and in the thickness direction T, it has a basic construction comprising a liquid-permeable top sheet 11 located on the torso-facing surface side of the absorbing body section 10, a liquid-impermeable back sheet 12 located on the non-torso-facing surface side of the absorbing body section 10, and an absorbent body 13 located between the two sheets and disposed, in the plan view, so that in the lengthwise direction L it extends straddling the lengthwise center axis line C′_{W} that runs in the widthwise direction W of the absorbing body section 10 while in the widthwise direction W it extends straddling the widthwise center axis line C′_{L} that runs in the lengthwise direction L, and it further comprises an abdominal side engaging member 17 and a dorsal side engaging member 18 (absorbing body section side engagement sections) disposed on the outer surface F₃ of each of both ends in the lengthwise direction L of the absorbing body section 10 (i.e., the abdominal side end E_{L3} and the dorsal side end E_{L4}), a tail opening 19 for insertion of the tail of the animal, disposed at a location between the absorbent body 13 and the dorsal side end E_{L4} in the plan view, and overlapping with the widthwise center axis line C′_{L}, a pair of side sheets 14 disposed on the torso-facing surface side of the top sheet 11 and sandwiching the widthwise center axis line C′_{L}, gather-forming elastic members 15 disposed on the inner side ends in the widthwise direction W of the side sheets 14 and running in the lengthwise direction L, and elastic members 16 disposed on the outer sides in the widthwise direction W of the absorbent body 13, sandwiching the absorbent body 13 in the plan view.

### [Top Sheet]

As shown in FIG. 4, the top sheet 11 to be used in the absorbing body section 10 for the first embodiment is composed of a liquid-permeable sheet that has an essentially rectangular longitudinal outer shape that is long in the lengthwise direction L, in the plan view, extending from the abdominal side end E_{L3} at one end across to the dorsal side end E_{L4} on the other end, in the lengthwise direction L of the absorbing body section 10, while also extending from the area near one side end across to the area near the other side end in the widthwise direction W, and it is disposed at a location on the torso-facing surface side in the thickness direction T of the absorbing body section 10, being able to directly contact with the body (especially the lower crotch region) of the animal on which it is to be worn.

According to the invention, the liquid-permeable sheet that may be used as the top sheet is not particularly restricted so long as it has the prescribed liquid-permeability, flexibility and feel on the skin allowing it to be used as a top sheet for an absorbing body section, and a fiber sheet such as a nonwoven fabric may be used. Among these it is preferred to use a nonwoven fabric from the viewpoint of liquid permeability, flexibility and feel on the skin, there being no particular restrictions on the nonwoven fabric, with suitable examples including spunlace nonwoven fabrics, air-through nonwoven fabrics, spunbond nonwoven fabrics, point bond nonwoven fabrics and meltblown nonwoven fabrics, as well as combinations thereof (for example, SMS nonwoven fabrics). The structure of the nonwoven fabric is also not particularly restricted, and the nonwoven fabric used may be a flat, nonporous nonwoven fabric, or it may be a porous nonwoven fabric or a nonwoven fabric having a protrusion-recess structure (a protrusion-recess structure or ridge-furrow structure with an undulating cross-section).

The constituent fibers of the nonwoven fabric to be used as the top sheet are also not particularly restricted, and examples include cellulosic fibers; and thermoplastic resin fibers of an olefin-based resin or polyester-based resin, any of which may be used alone or in combinations of two of more different types of fibers. Incidentally, the basis weight of such a nonwoven fabric is not particularly restricted so long as it does not inhibit the liquid permeability, and it is in the range of 6 g/m² to 50/m², for example.

The dimensional shape and thickness of the liquid-permeable sheet to be used as the top sheet for the invention are not particularly restricted so long as the liquid-permeable sheet can function as a top sheet for the absorbing body section, and any desired dimensional shape and thickness may be employed depending on the desired liquid permeability, flexibility, feel on the skin and strength.

### [Back Sheet]

As shown in FIG. 4, the back sheet 12 to be used in the absorbing body section 10 for the first embodiment is composed of a liquid-impermeable sheet that has an essentially rectangular longitudinal outer shape that is long in the lengthwise direction L, in the plan view, extending from the abdominal side end E_{L3} at one end across to the dorsal side end E_{L4} on the other end, in the lengthwise direction L of the absorbing body section 10, while also extending from one side end across to the other side end in the widthwise direction W, and it is disposed at a location on the non-torso-facing surface side in the thickness direction T of the absorbing body section 10, functioning so as to prevent penetration of excreta such as urine that are discharged by the animal on which it is worn.

According to the invention, the liquid-impermeable sheet that may be used as the back sheet is not particularly restricted so long as it can function to prevent permeation of excreta such as urine that have been discharged from an animal, and for example, a hydrophobic nonwoven fabric, SMS layered nonwoven fabric, liquid-impermeable plastic film, or a laminated sheet comprising any desired combination of these sheets, may be used.

The dimensional shape and thickness of the liquid-impermeable sheet to be used as the back sheet for the invention are not particularly restricted so long as the liquid-impermeable sheet can function as a back sheet for the absorbing body section, and any desired dimensional shape and thickness may be employed depending on the desired liquid impermeability, flexibility, air permeability and strength.

### [Absorbent Body]

As shown in FIG. 4, the absorbent body 13 to be used in the absorbing body section 10 for the first embodiment has a longitudinal outer shape that is long in the lengthwise direction L and extends in the lengthwise direction L straddling the center axis line C′_{W} that runs in the widthwise direction W of the absorbing body section 10, while extending in the widthwise direction W straddling the center axis line C′_{L} that runs in the lengthwise direction L, in the plan view when in the expanded state, the outer shape being an approximately hourglass shape that has its approximate center section in the lengthwise direction L narrowed toward the inner side in the widthwise direction W, and it is disposed between the top sheet 11 and the back sheet 12 in the thickness direction T of the absorbing body section 10, and is constructed of a water absorbing member that absorbs and retains excreta such as urine that have passed through the top sheet 11.

The water absorbing member to be used as the absorbent body for the invention is not particularly restricted so long as it can absorb and retain excreta such as urine that have been discharged from an animal, and any water absorbing member known in the relevant field may be used. Examples of such water absorbing members include those having an absorbent core formed of an absorbent member, covered with a hydrophilic core wrap sheet such as a tissue. The absorbent member composing the absorbent core may also be, for example, hydrophilic fibers or a superabsorbent polymer, and specifically, cellulose fibers such as fluff pulp or cotton; regenerated cellulose fibers such as rayon or fibril rayon; semi-synthetic cellulose fibers such as acetate or triacetate; hydrophilicized thermoplastic hydrophobic chemical fibers; granules composed of a superabsorbent polymer such as sodium acrylate copolymer; or a combination of any two or more of these.

According to the invention, the outer shape of the absorbent body section in the plan view is not limited to such a longitudinal shape that is essentially hourglass-shaped, and so long as the shape is a longitudinal shape such that the length dimension in the lengthwise direction L is longer than the width dimension in the widthwise direction W, any longitudinal shape (for example, rectangular or elliptical) may be employed according to the particular purpose of use or the body type of the animal. The outer dimensions, thickness and basis weight of the absorbing member to be used as the absorbent body are not particularly restricted so long as the absorbing member can function as an absorbent body of an absorbing body section, and any desired outer dimensions, thickness and basis weight may be employed according to the desired absorption performance and flexibility.

### [Side Sheets]

As shown in FIG. 4, the pair of side sheets 14 to be used in the absorbing body section 10 for the first embodiment are each composed of a sheet belt-shaped sheet member that is long in the lengthwise direction L, in the plan view, extending from the abdominal side end E_{L3} at one end across to the dorsal side end E_{L4} on the other end, in the lengthwise direction L of the absorbing body section 10, and they are disposed at both ends in the widthwise direction W of the absorbing body section 10 on the torso-facing surface side of the top sheet 11, in a manner sandwiching the widthwise center axis line C′_{L}. In each of the pair of side sheets 14, the ends on the outer sides in the widthwise direction W and both ends in the lengthwise direction L are joined on the surface on the torso-facing surface side of the top sheet 11, and the ends on the outer sides in the widthwise direction W are the fixed ends while the ends on the inner sides in the widthwise direction W are the free ends.

Also, each of the pair of side sheets 14 have their ends on the inner sides in the widthwise direction W folded over toward the top sheet 11 side, and the gather-forming elastic members 15 running in the lengthwise direction L are disposed in a manner inserted between the folded ends. Contraction of the gather-forming elastic members 15 causes the pair of side sheets 14 to rise from the top sheet 11 side when worn, allowing formation of three-dimensional gathers as anti-leakage walls against excreta.

According to the invention, the belt-shaped sheet members used as the side sheets are not particularly restricted so long as they can function as anti-leakage walls when the three-dimensional gathers are formed, and for example, they may be water-repellent or hydrophobic nonwoven fabrics. The nonwoven fabric to be used for the side sheets is not particularly restricted, and it may be any of various nonwoven fabrics such as, for example, a spunlace nonwoven fabric, spunbonded nonwoven fabric, thermal bonded nonwoven fabric, meltblown nonwoven fabric or air-through nonwoven fabric. The constituent fibers of the nonwoven fabric are not particularly restricted, and for example, synthetic fibers such as polyolefin-based fibers, polyester-based fibers or polyamide-based fibers, or cellulosic fibers such as rayon or cotton, may be used.

The same member used for the elastic members described above may also be used for the gather-forming elastic members.

### [Elastic Members]

For the first embodiment, as shown in FIG. 4, the elastic members 16 used in the absorbing body section 10 serve to impart contractive force to the absorbing body section 10 in the lengthwise direction L, and they are constructed with elastic yarns, being disposed with two each on both outer sides in the widthwise direction W of the absorbent body 13, and having lengths in the lengthwise direction that are at least longer than the length of the absorbent body 13 in the lengthwise direction. For the invention, incidentally, the number of elastic members disposed on each of both outer sides in the widthwise direction of the absorbent body is not particularly limited so long as the effect of the invention is not inhibited, and for example, the elastic members may be disposed with one each, or disposed with 3 each, on both outer sides in the widthwise direction of the absorbent body.

According to the invention, the elastic members that may be used in the absorbing body section are not particularly restricted so long as they can impart contractive force to the absorbing body section in the lengthwise direction when in the expanded state, and for example, any elastic members such as rubber threads or flat rubber made of natural rubber; or filamentous or belt-shaped molded thermoplastic elastomers such as urethane or ethylene-vinyl acetate copolymer (EVA), may be used.

### [Absorbing Body Section Side Engagement Section]

For the first embodiment, as shown in FIG. 4, the abdominal side engaging member 17 and dorsal side engaging member 18 (absorbing body section side engagement sections) used in the absorbing body section 10 have lateral outer shapes that are long in the widthwise direction W, extending from one side end to the other side end in the widthwise direction W of the absorbing body section 10, in the plan view, and they are disposed on the respective outer surfaces F₃ of both ends (i.e., the abdominal side end E_{L3} and dorsal side end E_{L4}) in the lengthwise direction L of the absorbing body section 10, in a manner allowing them to engage with the loop members 9 (band part side engagement members) disposed on the respective torso-facing surfaces F₁ in the center region AC and second region A₂ of the band part 1.

For the first embodiment, the abdominal side engaging member 17 and dorsal side engaging member 18 (absorbing body section side engagement sections) are formed of hook members having structures similar to the hook member 7 of the second engagement section or the hook member 5 of the third engagement section in the band part 1; however, the invention is not limited to such an aspect, and the absorbing body section side engagement sections may instead be formed of loop members. When the absorbing body section side engagement sections are to be formed by loop members, the band part side engagement section is formed of a hook member. However, since the band part side engagement section is preferably formed of a loop member as according to the first embodiment as described above, the absorbing body section side engagement sections are preferably formed of hook members.

According to the invention, the locations where the absorbing body section side engagement sections of the absorbing body section are disposed are not limited to the locations for the first embodiment, and for example, the absorbing body section side engagement sections may be disposed on one end, among the abdominal side end and dorsal side end located at both ends in the lengthwise direction of the absorbing body section, in the plan view, or they may be partially disposed in the widthwise direction at the ends. Incidentally, when the absorbing body section side engagement sections are disposed at one end among the dorsal side end and the abdominal side end in the plan view, the other end may be joined and anchored to the anchoring part on the torso-facing surface of the band part by any desired joining means other than engagement.

Furthermore, according to the invention, the absorbing body section side engagement sections are preferably disposed at the edges in the lengthwise direction of the absorbing body section (i.e., the lengthwise direction edges), on the outer surface and/or inner surface of at least one end among the dorsal side end and abdominal side end located at both ends in the lengthwise direction of the absorbing body section. If the absorbing body section side engagement sections of the absorbing body section are disposed in this manner, then when the absorbing body section side engagement sections are engaged and fastened with the torso-facing surface of the band part, they can be engaged and fastened up to the edges in the lengthwise direction of the absorbing body section, making it even less likely that the edges will crimp in the lengthwise direction of the absorbing body section or that the edges will catch onto the claws of the animal or onto external structures, causing the engagement between the absorbing body section side engagement sections and the torso-facing surface of the band part to become detached.

The construction of the absorbing body section in the absorbent article for an animal of the invention is not limited to that of the first embodiment, and any desired construction may be employed that is already publicly known in the field of absorbent articles for animals, such as disposable diapers and incontinence pads for animals (for example, a construction in which a back film or the like is disposed between the back sheet and absorbent body, or a construction in which a second sheet or the like is disposed on the torso-facing surface side and/or the non-torso-facing surface side of the absorbent body).

Additional embodiments of the invention (second embodiment to fourth embodiment), differing from the first embodiment described above only in the construction of the band part 1 (especially the construction relating to engagement with the absorbing body section side engagement sections) will now be described with reference to the accompanying drawings. The aspects of the construction other than the parts differing from the first embodiment are basically the same as the construction for the first embodiment, and therefore they will not be explained here.

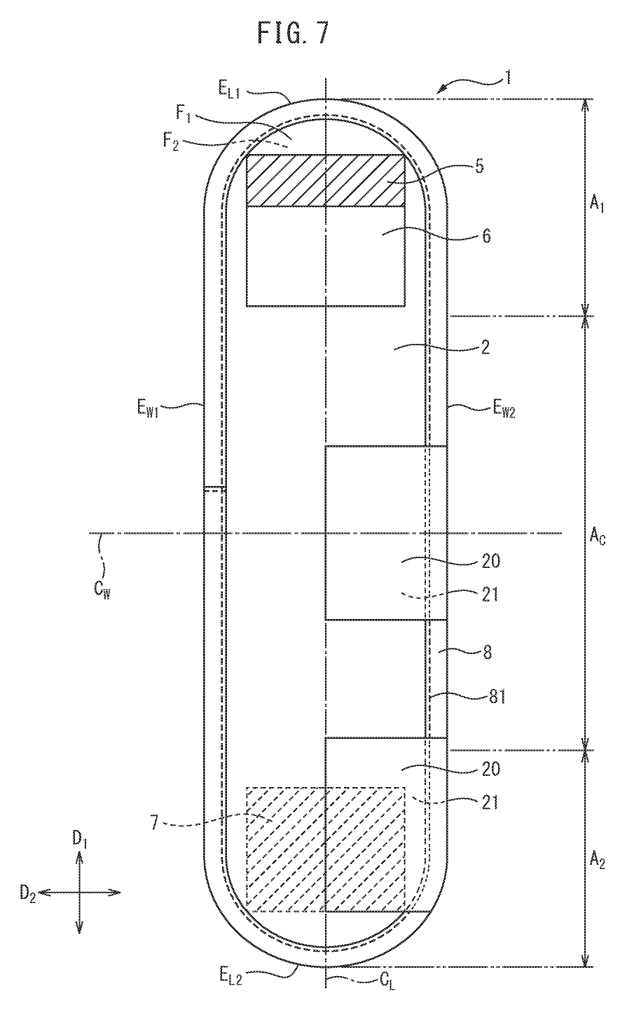

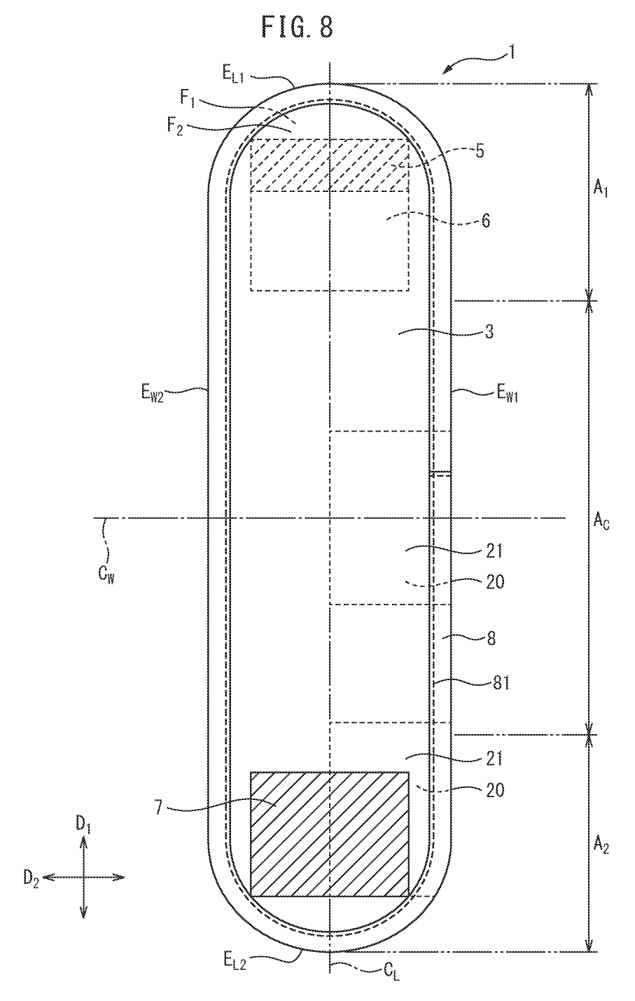

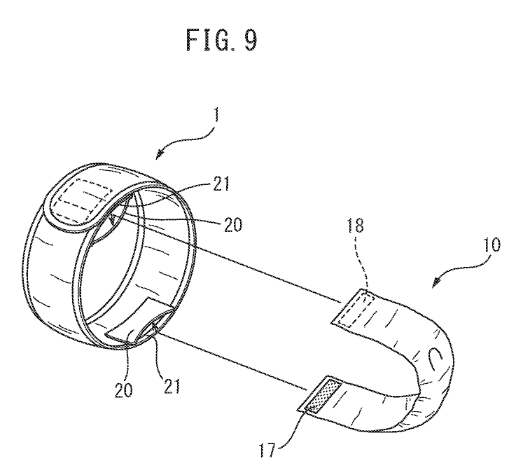

FIG. 7 is a plan view of the band part 1 of a disposable diaper for an animal according to the second embodiment of the invention, as viewed from the torso-facing surface side in the thickness direction, in the expanded state, and FIG. 8 is a plan view of the band part 1 as viewed from the non-torso-facing surface side in the thickness direction, in the expanded state. FIG. 9 is a perspective view illustrating engagement and fastening of the absorbing body section 10 to the band part 1 in a disposable diaper for an animal according to the second embodiment of the invention.

The band part 1 of the disposable diaper for an animal of the second embodiment is constructed, as shown in FIGS. 7 to 9, so that instead of the loop members 9 disposed on each of the torso-facing surfaces F₁ of the center region AC and second region A₂ of the band part 1 as the band part side engagement sections of the first embodiment, it has a first covering portion 20 that partially extends from the rear side end E_{W2} in the second direction D₂ located at the rear side of the animal when it is worn, toward the front side end E_{W1} in the second direction D₂, while partially extending in the first direction D₁, and a second covering portion 21 that extends in the first direction D₁ and the second direction D₂ so as to overlap with the first covering portion 20 in the thickness direction T′ of the band part 1, while being located on the non-torso-facing surface side of the first covering portion 20, with the abdominal side end E_{L3} and dorsal side end E_{L4} in the lengthwise direction L of the absorbing body section 10 being housed in the gap between the first covering portion 20 and the second covering portion 21.

For the second embodiment, the band part 1 comprises a band part side engagement section (not shown) on the non-torso-facing surface of the first covering portion 20, and is constructed so that the band part side engagement section can engage with the abdominal side engaging member 17 and dorsal side engaging member 18 (absorbing body section side engagement sections) of the absorbing body section 10, as described below.

For the second embodiment, incidentally, the band part side engagement section has the first covering portion 20 constructed of the same engaging sheet member as the outer surface member, and is thus formed over the entire non-torso-facing surface of the first covering portion 20; however, according to the invention there is no limitation to such an aspect, and for example, the band part side engagement section may be formed by situating a loop member on the non-torso-facing surface of the first covering portion.

In addition, the absorbing body section 10 of the disposable diaper for an animal of the second embodiment is constructed so that the abdominal side engaging member 17 and dorsal side engaging member 18 (absorbing body section side engagement sections) disposed on each of the outer surfaces F₃ of both ends (i.e., the abdominal side end E_{L3} and dorsal side end E_{L4}) in the lengthwise direction L of the absorbing body section 10 of the first embodiment, are disposed on the respective surfaces on the torso-facing surface side (i.e., the inner surface F₄) of the abdominal side end E_{L3} and dorsal side end E_{L4} in the lengthwise direction L of the absorbing body section 10, in a manner allowing them to engage with the band part side engagement section of the first covering portion 20 of the band part 1.

As shown in FIG. 9, the disposable diaper for an animal of the second embodiment constructed in this manner has the abdominal side end E_{L3} and dorsal side end E_{L4} in the lengthwise direction L of the absorbing body section 10 inserted inside the band part 1 (i.e., in the gap between the first covering portion 20 and the second covering portion) from the rear side in the front-rear direction of the animal, and has the abdominal side engaging member 17 and dorsal side engaging member 18 (absorbing body section side engagement sections), which are disposed on the respective inner surfaces F₄ of the abdominal side end E_{L3} and dorsal side end E_{L4}, engaging with the band part side engagement section on the inner surface of the band part 1 (i.e., the non-torso-facing surface of the first covering portion 20), for engagement and fastening of the absorbing body section 10 with the band part 1 in a freely detachable manner.

In the disposable diaper for an animal of the second embodiment, since the band part 1 comprises a band part side engagement section that engages with the abdominal side engaging member 17 and dorsal side engaging member 18 (absorbing body section side engagement sections) of the absorbing body section 10 on the surface on the non-torso-facing surface side of the first covering portion 20, and the location of engagement between the absorbing body section side engagement section and the band part side engagement section is covered by the first covering portion 20 and second covering portion 21, or in other words, it is not exposed on the surface on the torso-facing surface side or the surface on the non-torso-facing surface side of the band part 1, the ends of the absorbing body section 10 in the widthwise direction W are unlikely to catch onto the claws of the animal or onto external structures, the abdominal side end E_{L3} and dorsal side end E_{L4} in the lengthwise direction L of the absorbing body section 10 are unlikely to contact the torso of the animal (i.e., to rub and crimp or to detach from the torso of the animal), and the absorbing body section 10 can be more steadily engaged and fastened onto the band part 1.

For the second embodiment, the first covering portion 20 is constructed of an essentially rectangular engaging sheet member having prescribed lengths in the first direction and second direction, the engaging sheet member being joined to each torso-facing surface F₁ of the center region AC and second region A₂ of the band part 1 (more specifically, the torso-facing surface of the inner surface member 2), using any desired joining means such as stitching or an adhesive. The construction is such that the engaging sheet member and inner surface member are joined at the edge sections other than the edge section corresponding to the end at the rear side in the second direction D₂, among the outer perimeter edge sections of the engaging sheet member, and the abdominal side end E_{L3} and dorsal side end E_{L4} of the absorbing body section 10 can be inserted into the gap between the engaging sheet member and inner surface member, through the edge section corresponding to the end at the rear side in the second direction D₂.

Also, since the second covering portion 21 is constructed of a prescribed portion of the band part 1 facing the first covering portion 20 (i.e., the portion overlapping with the first covering portion 20 in the thickness direction T′), the second covering portion 21 has a prescribed length in the first direction and length in the second direction such that it overlaps with the first covering portion 20 in the thickness direction T′ of the band part 1, and it is located on the non-torso-facing surface side of the first covering portion 20. Therefore, the surface on the torso-facing surface side of the second covering portion 21 is formed by the torso-facing surface of the inner surface member 2 of the band part 1.

According to the invention, the second covering portion may be constructed of any sheet member, and the first covering portion may be constructed of a prescribed portion of the band part that overlaps with the second covering portion in the thickness direction. In this case, the band part side engagement section is formed on either or both the surface on the non-torso-facing surface side of the first covering portion (i.e., the non-torso-facing surface of the outer surface member) and the surface on the torso-facing surface side of the second covering portion (i.e., the torso-facing surface of the sheet member).

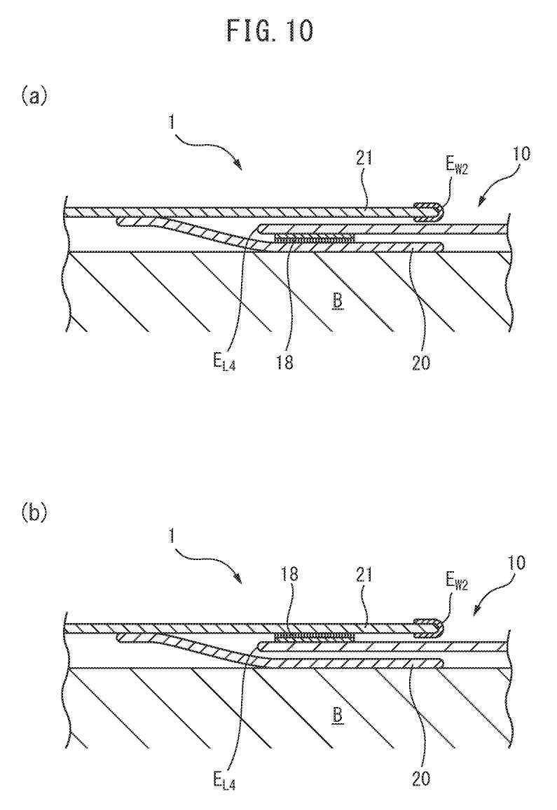

FIG. 10(a) is a partial cross-sectional view showing the state of the second embodiment of the invention, wherein the dorsal side engaging member 18, as the absorbing body section side engagement section of the absorbing body section 10, is engaged with the band part side engagement section on the surface of the non-torso-facing surface side of the first covering portion 20 of the band part 1.

In the disposable diaper for an animal of the second embodiment, as mentioned above, the band part 1 comprises a band part side engagement section on the surface on the non-torso-facing surface side of the first covering portion 20, while the absorbing body section 10 comprises an abdominal side engaging member 17 and dorsal side engaging member 18 (absorbing body section side engagement sections) on the respective inner surfaces F₄ of the abdominal side end E_{L3} and dorsal side end E_{L4}, the construction being such that the absorbing body section side engagement sections of the absorbing body section 10 engage with the band part side engagement section on the surface of the non-torso-facing surface side of the first covering portion 20 of the band part 1.

In the disposable diaper for an animal of the second embodiment constructed in this manner, as shown in FIG. 10(a), the location of engagement of the absorbing body section side engagement section and band part side engagement section is covered by the second covering portion 21 and is not exposed on the surface on the non-torso-facing surface side of the band part 1, and therefore the ends in the lengthwise direction L of the absorbing body section 10 (i.e., the abdominal side end E_{L3} and dorsal side end E_{L4}) are unlikely to catch onto the claws of the animal or onto external structures, and the absorbing body section 10 can be more steadily engaged and fastened with the band part 1. Furthermore, since it is possible for the second covering portion 21 of the band part 1 to crimp without engaging with the outer surface F₃ of the absorbing body section 10, the second covering portion 21 can be turned upward after the absorbing body section side engagement section and band part side engagement section have been engaged, to release the engagement between the engagement sections while adjusting the attachment position and tightening force of the absorbing body section 10. Thus, the disposable diaper for an animal of the second embodiment described above can more accurately engage and fasten the absorbing body section 10 onto the band part 1.

Moreover, as shown in FIG. 7 and FIG. 8, the first covering portion 20 and second covering portion 21 of the band part 1 of the second embodiment are constructed so that their lengths in the second direction D₂ are shorter than the full length of the band part in the second direction D₂. In the disposable diaper for an animal of the second embodiment constructed in this manner, since the first covering portion 20 and second covering portion 21 of the band part 1 do not extend up to the front side end E_{W1} in the second direction D₂ of the band part 1 (i.e., the front-rear direction of the animal when it is worn), then when the absorbing body section 10 has been engaged and fastened with the band part 1, the ends in the lengthwise direction L of the absorbing body section 10 (i.e., the abdominal side end E_{L3} and dorsal side end E_{L4}) are unlikely to be exposed from the front side end E_{W1} in the second direction D₂ of the band part 1 (i.e., the ends in the lengthwise direction L of the absorbing body section 10 are unlikely to catch onto the claws of the animal or onto external structures), and engagement between the absorbing body section side engagement sections and band part side engagement section can be more reliably maintained.

Moreover, for the second embodiment, as shown in FIG. 7 and FIG. 8, the first covering portion 20 and second covering portion 21 of the band part 1 have prescribed lengths in the first direction D₁ and are disposed so as to partially extend in the first direction D₁ of the band part 1. If the first covering portion 20 and second covering portion 21 of the band part 1 are disposed in this manner, the first covering portion 20 and second covering portion 21 will be unlikely to crimp when worn, and will easily return to their original state even if crimped, and therefore a disposable diaper for an animal according to the second embodiment having such a construction can more reliably maintain engagement between the absorbing body section side engagement section and the band part side engagement section.

Incidentally, although for the second embodiment the construction is such that the absorbing body section side engagement sections of the absorbing body section 10 engage with the band part side engagement section on the surface of the non-torso-facing surface side of the first covering portion 20 of the band part 1, the form of engagement between the absorbing body section side engagement section and the band part side engagement section is not particularly restricted for the invention, and for example, the construction may be such that the absorbing body section side engagement sections of the absorbing body section engage with the band part side engagement section on the surface on the torso-facing surface side of the second covering portion of the band part, or the construction may be such that they engage with both band part side engagement sections, i.e. the band part side engagement section of the surface on the torso-facing surface side of the first covering portion of the band part and the band part side engagement section on the surface on the torso-facing surface side of the second covering portion.

FIG. 10(b) is a partial cross-sectional view showing the state of a disposable diaper for an animal according to a modified example of the second embodiment of the invention, wherein the dorsal side engaging member 18 of the absorbing body section 10 is engaged with the band part side engagement section on the surface of the torso-facing surface side of the second covering portion 21 of the band part 1.

In the modified example of the second embodiment, the band part 1 comprises a band part side engagement section on the surface on the torso-facing surface side of the second covering portion 21, while the absorbing body section 10 comprises an abdominal side engaging member 17 and dorsal side engaging member 18 (absorbing body section side engagement sections) on the respective outer surfaces F₃ of the abdominal side end E_{L3} and dorsal side end E_{L4}, the construction being such that the absorbing body section side engagement sections of the absorbing body section 10 engage with the band part side engagement section on the surface of the torso-facing surface side of the second covering portion 21 of the band part 1.

Since a disposable diaper for an animal according to the modified example of the second embodiment is constructed so that the absorbing body section side engagement section of the absorbing body section 10 engages with the band part side engagement section on the surface of the torso-facing surface side of the second covering portion 21 of the band part 1, and does not engage with the surface on the non-torso-facing surface side of the first covering portion 20, the location of engagement of the band part side engagement section with the absorbing body section side engagement section is less affected by movement of the torso B of the animal, and engagement between the absorbing body section side engagement section and band part side engagement section can be more steadily maintained.

In another modified example of the second embodiment of the invention, the band part 1 comprises a band part side engagement section on each of the surface on the non-torso-facing surface side of the first covering portion 20 and the surface on the torso-facing surface side of the second covering portion 21, and the absorbing body section 10 comprises an absorbing body section side engagement section on both surfaces including the inner surface F₄ and outer surface F₃ of each of the abdominal side end E_{L3} and dorsal side end E_{L4}, the construction being such that the absorbing body section side engagement section disposed on each inner surface F₄ of the abdominal side end E_{L3} and dorsal side end E_{L4} of the absorbing body section 10 and the absorbing body section side engagement section disposed on each outer surface F₃ of the abdominal side end E_{L3} and dorsal side end E_{L4} of the absorbing body section 10 engage respectively with the band part side engagement section on the surface of the non-torso-facing surface side of the first covering portion 20 of the band part 1 and the band part side engagement section on the surface on the torso-facing surface side of the second covering portion 21.

In a disposable diaper for an animal according to the other modified example of the second embodiment constructed in such a manner, the abdominal side end E_{L3} and dorsal side end E_{L4} of the absorbing body section 10 are engaged and fastened with the band part side engagement section of the band part 1 on both the inner surface F₄ and the outer surface F₃, and therefore the absorbing body section 10 can be more firmly engaged and fastened to the band part 1.

According to the second embodiment, the first covering portion 20 and second covering portion 21 of the band part 1 are partially formed in the first direction D₁; however, there is no particular limitation to the manner of placement of the first covering portion and second covering portion according to the invention, and the first covering portion and second covering portion may instead be formed continuously from the one side end across to the other side end in the first direction D₁.

FIG. 11 is a perspective view of the band part 1 of a disposable diaper for an animal according to yet another modified example of the second embodiment of the invention.

In this additional modified example of the second embodiment, the first covering portion 20 and second covering portion 21 extend continuously in the first direction D₁. If the first covering portion 20 and second covering portion 21 of the band part 1 extend continuously in the first direction D₁ (the direction around the torso of the animal), then it will be possible to engage and fasten the absorbing body section 10 at the desired location in the first direction D₁ of the band part 1 (i.e., it will be possible to ensure a large adjusting width in the direction around the torso when the absorbing body section 10 is engaged and fastened to the band part 1), thus allowing the absorbing body section 10 to be engaged and fastened at the proper position of the band part 1 to match the body shape of the animal. This will allow the absorbent article for an animal having such a construction to even more accurately engage and fasten the absorbing body section onto the band part.

A third embodiment of the invention, differing from the second embodiment in the construction of the first covering portion 20 and second covering portion 21 of the band part, will now be described in detail with reference to the accompanying drawings. The aspects of the construction other than the parts differing from the previous embodiments are basically the same as the construction for the previous embodiments, and therefore they will not be explained here.

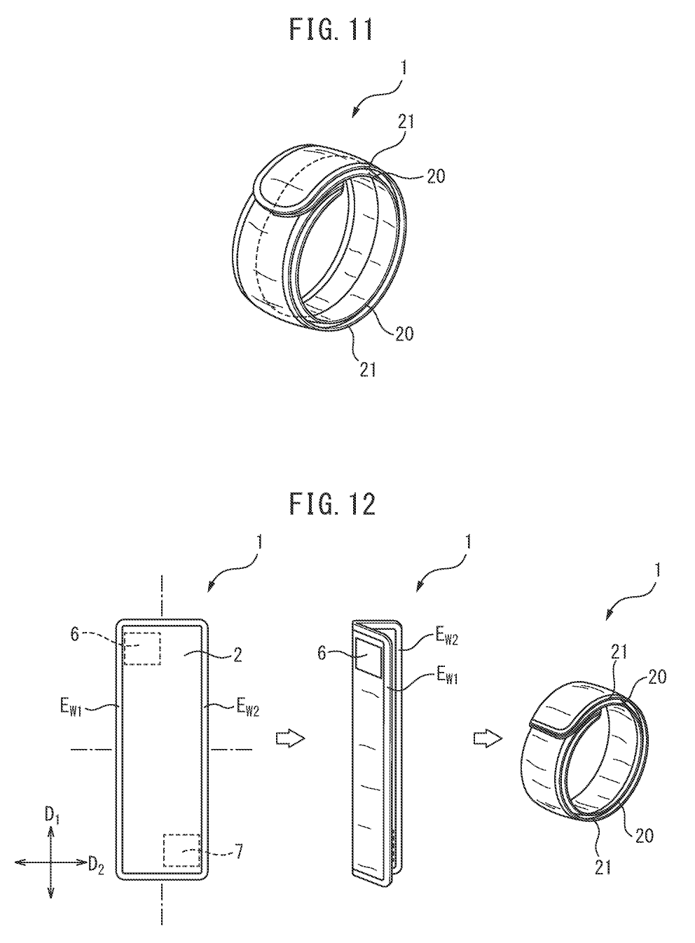

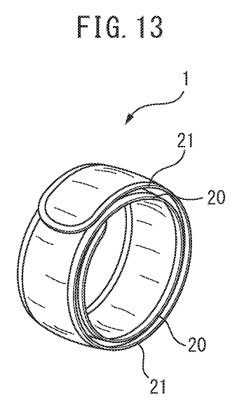

FIG. 12 is a schematic diagram showing an aspect of the band part 1 of a disposable diaper for an animal according to the third embodiment of the invention.

In the band part 1 of the third embodiment, as shown in FIG. 12, in the plan view when in the expanded state, the loop member 6 (first engagement section) is disposed on the non-torso-facing surface F₂ in the region further toward one side in the second direction than the center axis line CL in the second direction D₂, which runs in the first direction D₁ in the first region A₁ of the band part 1, while the hook member 7 (second engagement section) is disposed on the non-torso-facing surface F₂ in the region further toward the other side in the second direction than the center axis line CL in the second direction D₂, in the second region A₂ of the band part 1.

Also, as shown in FIG. 12, the band part 1 is folded over in the second direction D₂ with the center axis line CL in the second direction D₂ running in the first direction D₁ as the folding axis, and then wrapped around the torso of the animal in the same manner as the first embodiment, while in the dorsal region of the animal, the first region A₁ of the band part 1 overlaps onto the second region A₂, and the loop member 6 (first engagement section) disposed in the first region A₁ is engaged and fastened with the hook member 7 (second engagement section) disposed in the second region A₂. When the folded band part 1 is wrapped around the torso of the animal, it is wrapped around the torso of the animal in such a manner that the center axis line CL in the second direction D₂, as the folding axis, is at the front side of the animal.

Thus, as shown in FIG. 12, the band part 1 of the third embodiment comprises, when it is worn, a first covering portion 20 formed by the region on one side in the second direction D₂ with respect to the center axis line CL in the second direction D₂, and a second covering portion 21 formed by the region on the other side in the second direction D₂ with respect to the center axis line CL in the second direction D₂. For the third embodiment, incidentally, the band part side engagement section (not shown) is provided on either or both the surface on the non-torso-facing surface side of the first covering portion 20 and the surface on the torso-facing surface side of the second covering portion 21.

For the third embodiment, the first covering portion 20 and second covering portion 21 are formed so as to extend continuously in the first direction D₁ (the direction around the torso of the animal), and therefore it is possible to engage and fasten the absorbing body section 10 at the desired location in the first direction D₁ of the band part 1 (i.e., it is possible to ensure a large adjusting width in the direction around the torso when the absorbing body section 10 is engaged and fastened to the band part 1), allowing the absorbing body section 10 to be engaged and fastened at the proper position of the band part 1 to match the body shape of the animal. In addition, with the third embodiment, since the folded band part 1 is wrapped around the torso of the animal so that the center axis line CL of the folding axis in the second direction D₂ is at the front side of the animal, when the absorbing body section 10 has been engaged and fastened with the folded band part 1, the ends in the lengthwise direction L of the absorbing body section 10 (i.e., the abdominal side end E_{L3} and dorsal side end E_{L4}) are not exposed from the front side in the second direction D₂ of the band part 1 (i.e., the front-rear direction of the animal) (or in other words, the ends in the lengthwise direction L of the absorbing body section 10 do not catch onto the claws of the animal or onto external structures), and engagement between the absorbing body section side engagement sections and band part side engagement section can be more reliably maintained.

A fourth embodiment of the invention, differing from the second embodiment and third embodiment in the construction of the first covering portion 20 and second covering portion 21 of the band part, will now be described in detail with reference to the accompanying drawings. The aspects of the construction other than the parts differing from the previous embodiments are basically the same as the construction for the previous embodiments, and therefore they will not be explained here.

FIG. 13 is a perspective view of the band part 1 of a disposable diaper for an animal according to a fourth embodiment of the invention.

In the fourth embodiment, the band part 1 is constructed so that its length in the first direction D₁ is at least two times longer than the length in the first direction D₁ of the band part 1 in the embodiments described above (i.e., so that it wraps around the torso of the animal at least twice). As shown in FIG. 13, the band part 1 is wrapped around the torso of the animal in a tubular form that is wrapped at least twice in the first direction D₁.

Thus, as shown in FIG. 13, the band part 1 of the fourth embodiment comprises, when it is worn, a first covering portion 20 formed by the first wrapped portion situated furthest on the torso-facing surface side, when in a multilayer tubular form wrapped at least twice in the first direction D₁, and a second covering portion 21 formed by the first covering portion 20 and the second wrapped portion that is adjacent to the non-torso-facing surface side. For the fourth embodiment as well, the band part side engagement section (not shown) is provided on either or both the surface on the non-torso-facing surface side of the first covering portion 20 and the surface on the torso-facing surface side of the second covering portion 21.

For the fourth embodiment, the first covering portion 20 and second covering portion 21 are formed so as to extend continuously in the first direction D₁ (the direction around the torso of the animal), and therefore it is possible to engage and fasten the absorbing body section 10 at the desired location in the first direction D₁ of the band part 1 (i.e., it is possible to ensure a large adjusting width in the direction around the torso when the absorbing body section 10 is engaged and fastened to the band part 1), allowing the absorbing body section 10 to be engaged and fastened at the proper position of the band part 1 to match the body shape of the animal. Furthermore, since the band part 1 is wrapped at least twice in a continuous manner around the torso of the animal, it is possible to ensure a large adjustment width for the size around the torso of the animal, by loosening or tightening the degree of wrapping.

Moreover, since for the fourth embodiment, the first covering portion 20 and second covering portion 21 are formed so as to extend continuously in the second direction D₂ (the front-rear direction of the animal), it is possible to ensure a large adjustment width in the front-rear direction of the animal when the absorbing body section 10 is engaged and fastened on the band part 1, allowing the absorbing body section 10 to be more precisely and steadily matched with the lower crotch region of the animal.

For the fourth embodiment, incidentally, the number of times the band part 1 is wrapped is not particularly restricted and the band part 1 may even be wrapped 3 or more times in the first direction D₁.

For the fourth embodiment, the band part 1 used had a length in the first direction D₁ that was at least twice the length of the band part 1 of each of the previous embodiments in the first direction D₁ (being wrapped at least twice around the torso of the animal), thus forming a multilayer tubular form wrapped at least twice around the first direction D₁; however, the means for forming the multilayer tubular form is not limited to such an aspect, and as a modified example of the fourth embodiment, for example, the band part may be constructed of two belt-shaped members with lengths in the first direction that are approximately the same as the lengths of the band parts of the previous embodiments in the first direction. In this case, the two belt-shaped members are constructed so that the two sides can be mutually bonded by any bonding means such as engagement; however, if the construction is such that the rear side end in the second direction is at least partially unable to be bonded, then it is possible to form a first covering portion that is composed of a first belt-shaped member and a second covering portion that is composed of another belt-shaped member, when the article is worn.

In this modified example of the fourth embodiment as well, the first covering portion 20 and second covering portion 21 are formed so as to extend continuously in the first direction D₁ (the direction around the torso of the animal), and therefore it is possible to engage and fasten the absorbing body section 10 at the desired location in the first direction D₁ of the band part 1 (i.e., it is possible to ensure a large adjusting width in the direction around the torso when the absorbing body section 10 is engaged and fastened to the band part 1), allowing the absorbing body section 10 to be engaged and fastened at the proper position of the band part 1 to match the body shape of the animal. Moreover, since for the modified example of the fourth embodiment as well, the first covering portion 20 and second covering portion 21 are formed so as to extend continuously in the second direction D₂ (the front-rear direction of the animal), it is possible to ensure a large adjustment width in the front-rear direction of the animal when the absorbing body section 10 is engaged and fastened on the band part 1, allowing the absorbing body section 10 to be more precisely and steadily matched with the lower crotch region of the animal.

In addition, since the length in the first direction can be absolutely minimized in the modified example of the fourth embodiment, the handleability when worn and the washability are excellent.

The present invention can be applied to a variety of absorbent articles for animals, other than a disposable diaper for an animal according to the embodiments described above, such as a (light) incontinence pad for an animal, for example. Furthermore, the absorbent article for an animal of the invention is not restricted to the embodiments described above or their modifications, and can incorporate appropriate combinations and modifications within a range that is not outside of the object and gist of the invention. Incidentally, the ordinal terms “first” and “second” as used throughout the present description serve merely to distinguish between the numbered embodiments and are not used to mean any relative ordering, precedence or importance.

### REFERENCE SIGNS LIST

1 Band part
2 Inner surface member
3 Outer surface member
4 Core member
5 Hook member (third engagement section)
6 Loop member (first engagement section)
7 Hook member (second engagement section)
8 Rigidity-reinforcing member
9 Loop member (band part side engagement member)
10 Absorbing body section (disposable diaper main body)
11 Top sheet
12 Back sheet
13 Absorbent body
14 Side sheet
15 Gather-forming elastic member
16 Elastic member
17 Abdominal side engaging member (absorbing body section side engagement section)
18 Dorsal side engaging member (absorbing body section side engagement section)

1. An absorbent article for an animal comprising:
a band part that is fitted in a freely detachable manner around a torso of an animal and has a torso-facing surface facing the torso of the animal when it is worn, and a non-torso-facing surface located on a side opposite the torso-facing surface and an absorbing body section disposed along a dorsal region, lower crotch region; and
abdominal region of the animal and having at least one end, from among a dorsal side end located on a dorsal region side of the animal and an abdominal side end located on an abdominal region side of the animal, engaged and fastened in a freely detachable manner with the band part, wherein
the absorbing body section has a longitudinal shape with a lengthwise direction and a widthwise direction in a plan view when in an expanded state, while having an inner surface that faces a skin of the animal when it is worn, and an outer surface on an opposite side from the inner surface, and
at least one end from among the dorsal side end and abdominal side end located at both ends in the lengthwise direction comprises, on at least one surface from among the inner surface and outer surface, an absorbing body section side engagement section that is inserted from a rear side in a front-rear direction of the animal, into a torso-facing surface side of the band part or an interior of the band part, and engages with the torso-facing surface or inner surface of the band part.

2. The absorbent article for an animal according to claim 1, wherein
the band part has a first direction corresponding to a direction around the torso of the animal and a second direction corresponding to the front-rear direction of the animal, while also having a first covering portion that extends from a rear side end in the second direction, located on the rear side of the animal when it is worn, toward a front side end in the second direction, and at least partially extending in the first direction, and a second covering portion that extends in the first direction and the second direction so as to overlap with the first covering portion in a thickness direction of the band part, and is located on a non-torso-facing surface side of the first covering portion,
the inner surface of the band part being formed by a surface on the non-torso-facing surface side of the first covering portion and a surface on the torso-facing surface side of the second covering portion, and
further comprises a band part side engagement section on at least one surface, of the surface on the non-torso-facing surface side of the first covering portion and the surface on the torso-facing surface side of the second covering portion, that engages with the absorbing body section side engagement section.

3. The absorbent article for an animal according to claim 2, wherein
the band part comprises the band part side engagement section on the surface on the non-torso-facing surface side of the first covering portion,
the absorbing body section comprises the absorbing body section side engagement section on the inner surface, and
the absorbing body section side engagement section of the absorbing body section engages with the band part side engagement section of the surface on the non-torso-facing surface side of the first covering portion.

4. The absorbent article for an animal according to claim 2, wherein
the band part comprises the band part side engagement section on the surface on the torso-facing surface side of the second covering portion,
the absorbing body section comprises the absorbing body section side engagement section on the outer surface, and
the absorbing body section side engagement section of the absorbing body section engages with the band part side engagement section of the surface on the torso-facing surface side of the second covering portion.

5. The absorbent article for an animal according to claim 2, wherein
the band part comprises the band part side engagement section on both the surface on the non-torso-facing surface side of the first covering portion and the surface on the torso-facing surface side of the second covering portion,
the absorbing body section comprises the absorbing body section side engagement section on both the inner surface and the outer surface, and
the absorbing body section side engagement section on the inner surface and the absorbing body section side engagement section on the outer surface of the absorbing body section engage, respectively, with the band part side engagement section of the surface on the non-torso-facing surface side of the first covering portion and the band part side engagement section of the surface on the torso-facing surface side of the second covering portion, of the band part.

6. The absorbent article for an animal according to claim 2, wherein
the first covering portion and second covering portion have shorter lengths in the second direction than a full length of the band part in the second direction.

7. The absorbent article for an animal according to claim 6, wherein
the first covering portion and second covering portion extend partially in the first direction.

8. The absorbent article for an animal according to claim 2, wherein
the first covering portion and second covering portion extend continuously in the first direction.
